(19) United States
(12) Patent Application Publication
(10) Pub. No.: US 2009/0011367 A1
(43) Pub. Date: Jan. 8, 2009

(54) INTERFACE BINDER, RESIST COMPOSITION CONTAINING THE SAME, LAMINATE FOR FORMING MAGNETIC RECORDING MEDIUM HAVING LAYER CONTAINING THE SAME, MANUFACTURING METHOD OF MAGNETIC RECORDING MEDIUM USING THE SAME, AND MAGNETIC RECORDING MEDIUM PRODUCED BY THE MANUFACTURING METHOD

(75) Inventors: Tadashi Omatsu, Kanagawa (JP); Masakazu Nishikawa, Kanagawa (JP); Kenichi Moriwaki, kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/167,648

(22) Filed: Jul. 3, 2008

(30) Foreign Application Priority Data
Jul. 6, 2007 (JP) 2007-179069

(51) Int. Cl. G11B 5/00; G03C 1/00; C08L 39/04

(52) U.S. Cl. 430/287.1; 428/800; 525/203

(57) ABSTRACT

To provide an interface binder for binding a resist layer and a laminate for forming magnetic recording medium having a substrate and a magnetic layer, the interface binder containing a first functional group crosslinkable with a surface of the laminate, and a second functional group crosslinkable with the resist layer.

### BACKGROUND OF THE INVENTION

1. Field of the Invention

The present invention relates to an interface binder, a resist composition containing the interface binder, a laminate for forming magnetic recording medium having a layer composed of the interface binder, a manufacturing method of a magnetic recording medium using the interface binder, and a magnetic recording medium produced by the manufacturing method.

2. Description of the Related Art

In recent years, discrete track media (DTM) and bit patterned media (BPM), which have a patterned magnetic layer, have been suggested as high-recording density magnetic recording media and have been replacing conventional magnetic recording media with a continuous magnetic layer (see Japanese Patent Application Laid-Open (JP-A) Nos. 09-97419 and 2006-120299).

Examples of methods of manufacturing patterned magnetic recording media include those involving the use of electron beams (EB), nanoimprint lithography (NIL), or self-organizing polymers. Among other methods, nanoimprint lithography holds promise for its productivity, simplicity, fine patterning capability that enables fine pattern formation with high position accuracy, etc.

NIL is a pattern transfer method that uses a template (resist) having a pattern transferred from a patterned mold. More specifically, the pattern transfer process includes the steps of placing a template onto a substrate, pressing a mold against the template for molding, fixing the template shape by temperature control or by irradiation with light, and separating the mold from the template.

Patterning of magnetic recording medium requires that a nanoscale concentric pattern be transferred onto a 1.8-3.5 inch disc—a large-size target for imprinting—with positional accuracy in the order of nanometers without destroying the pattern shape. When this requirement is met, it becomes possible for the head of a hard disk drive to write and read the magnetic recording medium without any troubles.

Thus, it is demanded to establish means for achieving fine patterning capability and positional accuracy upon pattern transfer onto an entire surface of a magnetic recording medium by NIL.

NIL research directed to semiconductors, microelectromechanical systems (MEMS) and microarrays has been conducted, wherein improvements in fineness and aspect ratio are made so as to increase the fine patterning capability.

In the case of magnetic recording media, pattern transfer onto the disc needs to be done at one time with high positional accuracy, which requires both fine patterning capability and positional accuracy over a large area. The requirements regarding to fine patterning capability and positional accuracy for patterning of magnetic recording media are stricter than those for conventional applications such as manufacture of semiconductors and MEMS.

The NIL process has met with a problem of positional accuracy during imprinting. To overcome this problem there have been suggested several methods directed to improvement in positional accuracy during imprinting: A method that involves reading of alignment marks and stage position control (see JP-A No. 2006-40321); an imprint method using a patterned mold (see JP-A No. 2006-5023); and so forth. On the other hand, techniques for achieving both processing accuracy and positional accuracy in the order of nanometers over a large area have not yet been fully established.

One of the major problems associated with imprinting on a large area of a magnetic recording disc is low imprint accuracy, which is caused by displacement between the mold and resist that occurs during a series of steps—from imprinting to mold separation. Causes of this displacement include, for example, forces applied to the mold, resist layer, and laminate for forming magnetic recording medium; pressure to the mold; the direction of pressure to the mold; controlled temperature; UV irradiation dose; temperature distribution; mold material; and non-uniformity for instance in the thickness of the resist layer. This displacement not only reduces pattern position accuracy, but destroys the nanoscale pattern itself by stripping or the like

It has been highly difficult to realize patterned media for magnetic recording media with sufficient performance, and therefore, establishment of a technology has been demanded that can obtain such patterned magnetic recording media.

Meanwhile, as a technique to reduce the occurrence of pattern crumbling during the imprint process for improved pattern shape stability, a method is suggested in which fine inorganic particles are added in the resist composition (see JP-A No.2003-82043). With the method disclosed by JP-A No.2003-82043, however, adhesion between the resist layer and laminate for forming magnetic recording medium is not sufficient and, particularly in the case of nanoscale imprint patterning, the occurrence of pattern crumbling due to stripping of the resist layer from the laminate cannot be sufficiently reduced. Moreover, when the patterned laminate for forming magnetic recording medium is inserted into a hard disk drive as a magnetic recording medium, residual fine particles impair the flying ability of the head, resulting in destruction of the magnetic recording medium inserted.

In addition, as a technique to reduce the occurrence of stripping of a patterned resist layer from a laminate for forming magnetic recording medium, a method is suggested in which a resist composition containing a coupling agent is employed (see JP-A No. 2004-34325). In the method disclosed by JP-A No. 2004-34325, however, a coupling agent having bonding property with respect to both of the resist layer and laminate is not used as an essential ingredient, and in addition, activation of the laminate to be processed is insufficient. Consequently, this method uses a large amount of coupling agent and therefore the ability with which the patterned resist layer is removed decreases. Moreover, since the coupling agent is undesirably converted into sol form in actual use, sufficient fine patterning capability cannot be obtained that can satisfy the requirements of fine patterning capability by nanoimprint lithography, thinness of the residual layer after imprinting, and processability of the laminate for forming magnetic recording medium.

Regarding adhesion between such a resist layer and a laminate for forming magnetic recording medium in conventional lithography, it has been only necessary for the adhesion to be derived from affinity between the resist layer and laminate such that the resist pattern is not removed during wet etching but dissolved away by means of organic solvent.

### BRIEF SUMMARY OF THE INVENTION

An object of the present invention is to solve the problems pertinent in the art and to achieve the following objective. More specifically, it is an object of the present invention to provide an interface binder that can achieve fine pattern formation and pattern position accuracy over a large area; a resist composition containing the interface binder; a laminate for forming magnetic recording medium having a layer composed of the interface binder; a manufacturing method of a magnetic recording medium using the interface binder; and a magnetic recording medium produced by the manufacturing method.

The present inventors conducted extensive studies and established that even when displacement occurred between the resist layer and laminate for forming magnetic recording medium, increasing the bonding strength between the resist layer and laminate reduces influences of the displacement on the final imprint performance, whereby fine pattern formation and pattern position accuracy can be obtained at the same time.

For patterning of magnetic recording media, after nanoimprint lithography, it is necessary to remove both of the resist layer and interface binder after patterning of the magnetic layer by etching; therefore, such a technology is demanded that enables to establish adhesion between the resist layer and laminate while ensuring resist layer removal property after patterning. It has been also established that oxygen plasma treatment, oxygen ashing treatment, UV ozone treatment or the like can improve resist layer removal property and thereby the adhesion between the resist layer and laminate can be established while ensuring the resist layer removal property after patterning.

Moreover, it has been established that surface treatment of the laminate with an interface binder that has good compatibility with the resist layer, in combination with surfactant, improves uniformity of the coated resist layer thickness.

Furthermore, it has been established that in the present invention, great force is applied to the resist layer upon nanoimprint lithography and the resist layer and the laminate for forming magnetic recording medium are covalently bonded, whereby the interface between the resist layer and laminate remains stable upon imprinting without being destroyed due to stress.

Means to solve to the foregoing problems are as follows:

<1> An interface binder for binding a resist layer and a laminate for forming magnetic recording medium having a substrate and a magnetic layer, the interface binder containing:

a first functional group crosslinkable with a surface of the laminate; and a second functional group crosslinkable with the resist layer.

<2> The interface binder according to <1>, wherein the laminate includes a hydroxyl group on the surface thereof, the first functional group is crosslinkable with the hydroxyl group, the resist layer contains a crosslinkable monomer, and the second functional group is crosslinkable with the crosslinkable monomer.
<3> The interface binder according to any one of <1> and <2>, wherein the interface binder is decomposable by any of oxygen plasma treatment, oxygen ashing treatment and UV ozone treatment.
<4> The interface binder according to any one of <1> to <3>, wherein the interface binder is composed of at least one of a silane coupling agent and a carboxylic anhydride.
<5> A nanoimprint resist composition, containing the interface binder according to any one of <1> to <4>.
<6> A laminate for forming magnetic recording medium, including:

a substrate;

a magnetic layer; and

a layer on a surface of the laminate,

wherein the layer on the surface of the laminate is composed of the interface binder according to any one of <1> to <4>.

<7> A method of manufacturing a magnetic recording medium having a laminate for forming magnetic recording medium having a substrate and a magnetic layer, the method including:

treating a surface of the laminate with the interface binder according to any one of <1> to <4>.

<8> The method according to <7>, further including forming a resist layer on the laminate whose surface has been treated in the surface treatment.
<9> The method according to any one of <7> and <8>, further including activating the surface of the laminate by any of UTV irradiation, oxygen plasma treatment, oxygen ashing treatment, alkali treatment and acid treatment, so that the mole ratio of OH group-containing elements becomes 20% or more over the surface of the laminate.
<10> The method according to any one of <7> to <9>, further including ablating, by any of oxygen plasma treatment, oxygen ashing treatment and UV ozone treatment, a single or multiple layers that contain at least the interface binder and that are formed in the surface treatment step at a position closer to the laminate surface than is the magnetic layer.
<11> A magnetic recording medium produced by the method according to any one of <7> to <10>.

According to the present invention, it is possible to provide an interface binder that can solve the problems pertinent in the art, can achieve the foregoing object, and can achieve fine pattern formation and pattern position accuracy at the same time over a large area; a resist composition containing the interface binder, a laminate for forming magnetic recording medium having a layer composed of the interface binder; a manufacturing method of a magnetic recording medium using the interface binder; and a magnetic recording medium produced by the manufacturing method.

### BRIEF DESCRIPTION OF THE SEVERAL VIEWS OF THE DRAWINGS

FIG. 1A shows a first flow in an example of a manufacturing method of magnetic recording medium of the present invention.

FIG. 1B shows a second flow in the example of a manufacturing method of magnetic recording medium of the present invention.

FIG. 1C shows a third flow in the example of a manufacturing method of magnetic recording medium of the present invention.

FIG. 1D shows a fourth flow in the example of a manufacturing method of magnetic recording medium of the present invention.

FIG. 1E shows a fifth flow in the example of a manufacturing method of magnetic recording medium of the present invention.

FIG. 2 shows a schematic structure of a mold structure 100 shown in FIG. 1A.

### DETAILED DESCRIPTION OF THE INVENTION

Hereinafter, an interface binder, resist composition containing the interface binder, laminate for forming magnetic recording medium having a layer composed of the interface binder, manufacturing method of a magnetic recording medium using the interface binder, and magnetic recording medium produced by the manufacturing method, according to the present invention will be described with reference to the drawings.

### (Interface Binder)

The interface binder is an agent for bonding a resist layer and a laminate for forming magnetic recording medium.

The interface binder contains a first functional group and a second functional group, and further contains additional functional group(s) as needed, wherein the first functional group is crosslinkable with a surface of the laminate, and the second functional group is crosslinkable with the resist layer.

It is preferable that the laminate for forming magnetic recording medium have a hydroxyl group on its surface, that the first functional group be crosslinkable with the hydroxyl group, that the resist layer contain a crosslinkable monomer, and that the second functional group be crosslinkable with the crosslinkable monomer.

The interface binder is preferably composed of at least one of silane coupling agent and carboxylic anhydride, for example.

### <Laminate for Forming Magnetic Recording Medium>

The laminate for forming magnetic recording medium is a subject to be processed for forming magnetic recording medium, and will be detailed later.

### <Resist Layer>

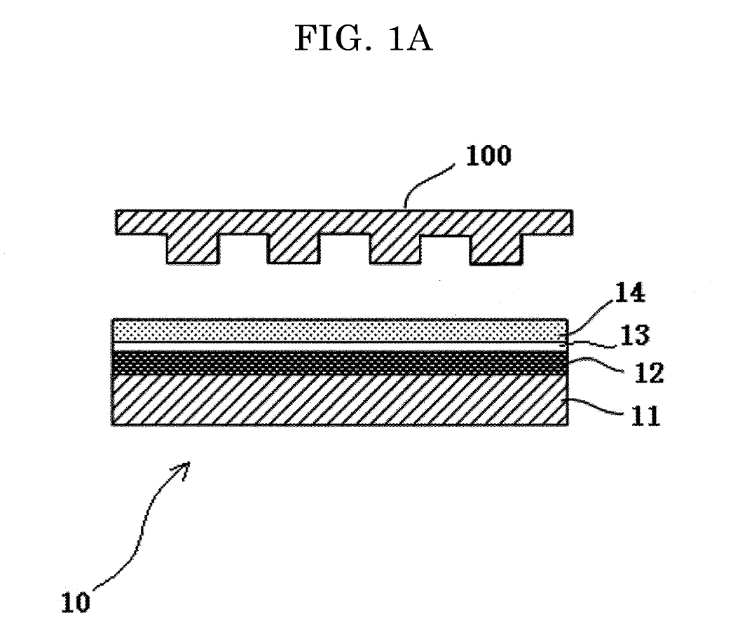

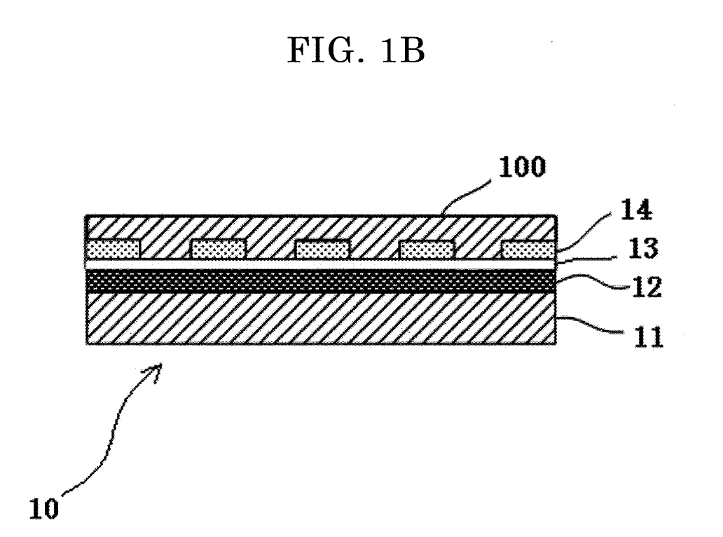

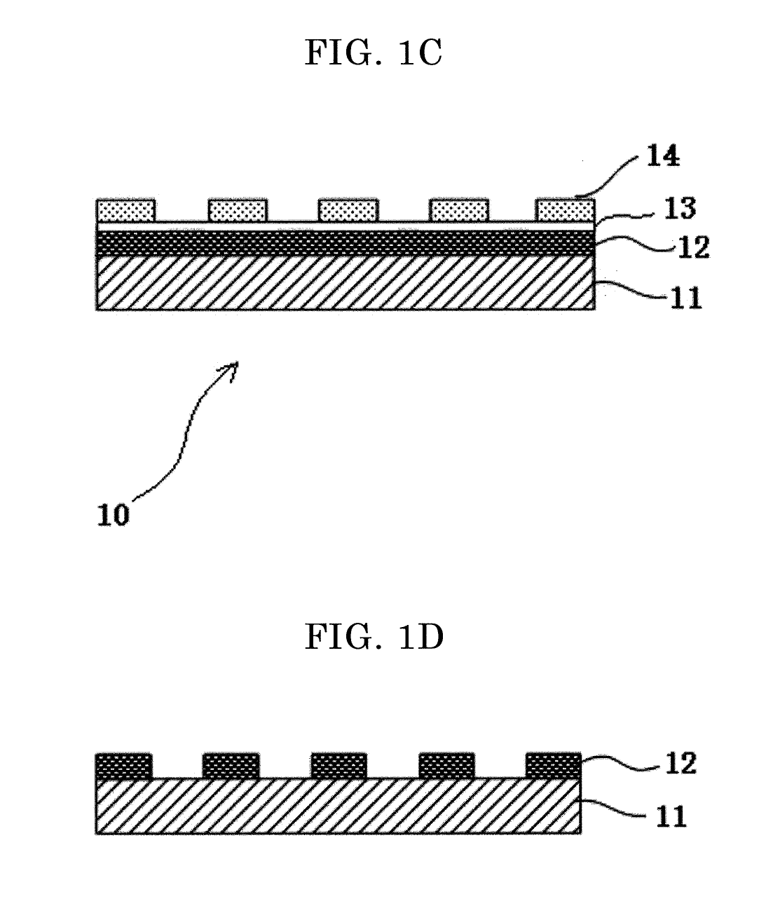

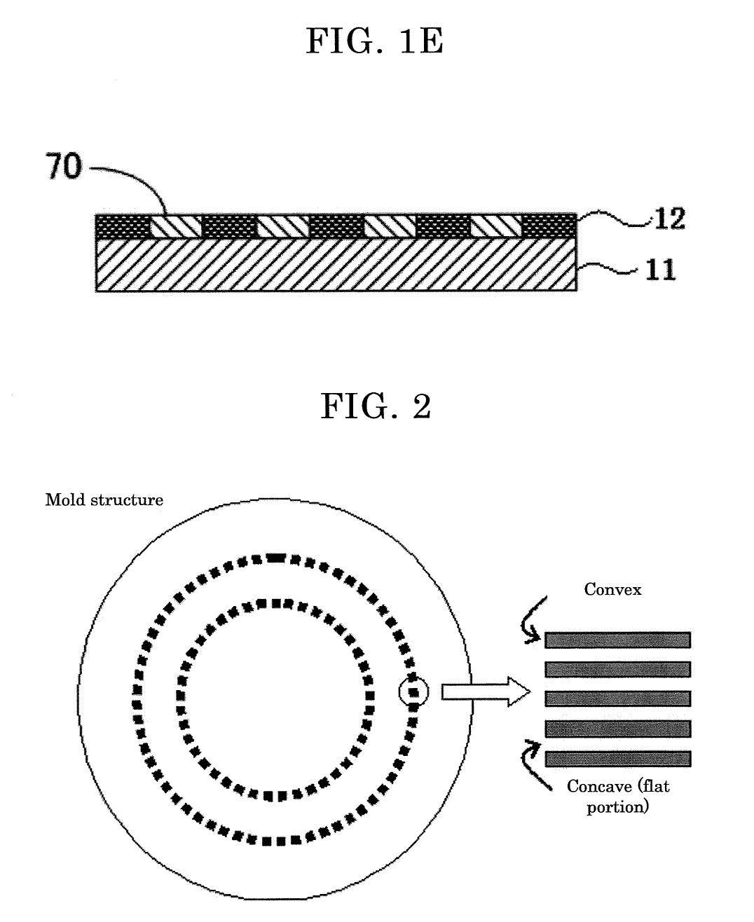

A resist layer 14 shown in FIG. 1A may be made of positive resist material or negative resist material. The method of forming the resist layer 14 is not specifically limited and can be appropriately selected from known coating methods; for example, spin coating can be suitably employed. The thickness of the resist layer 14 is preferably 5 nm to 200 nm.

### <First Functional Group>

The first functional group is not specifically limited as long as it is crosslinkable with a surface of a laminate for forming magnetic recording medium, and can be appropriately selected from those known in the art according to the intended purpose; for example, alkoxysilane site, and carboxylic anhydride site that is crosslinkable with OH group can be employed.

### <Second Functional Group>

The second functional group is not specifically limited as long as it is crosslinkable with the resist layer 14 (resist resin), and can be appropriately selected from those known in the art according to the intended purpose.

### <Additional Functional Group>

The additional group is not specifically limited and can be appropriately selected according to the intended purpose.

### <Silane Coupling Agent>

It is only necessary for the silane coupling agent to have in one molecule an alkoxysilane site that is crosslinkable with a surface of a laminate for forming magnetic recording medium, and a variety of functional groups that are crosslinkable with the resist layer 14 (resist resin); examples include, for example, vinylsilanes such as ↓-isocyanatepropyltriethoxysilane, 3-acryloyloxypropyltrimethoxysilane, 3-methacryloylpropyltrimethoxysilane, vinyltrichlorosilane, vinyltris(β-methoxyethoxy)silane, vinyltriethoxysilane, and vinyltrimethoxysilane; acrylsilanes such as γ-methacryloxypropyltrimethoxysilane, and γ-methacryloxypropylmethyldimethoxysilane; epoxysilanes such as β-(3,4-epoxycyclohexyl)ethyltrimethoxysilane, γ-glycidoxypropyltrimethoxysilane, and γ-glycidoxypropylmethyldiethoxysilane; amino silanes such as N-β-(aminoethyl)-γ-aminopropyltrimethoxysilane, N-β-(aminoethyl)-γ-aminopropylmethyldimethoxysilane, γ-aminopropyltrimethoxysilane, and N-phenyl-γ-aminopropyltrimethoxysilane; and as other silane coupling agents, γ-mercaptopropyltrimethoxysilane, γ-chloropropylmethyldimethoxysilane, and γ-chloropropylmethyldiethoxysilane.

### <Carboxylic Anhydride>

It is only necessary for the carboxylic anhydride to have in one molecule a carboxylic anhydride site that is crosslinkable with OH groups on a laminate for forming magnetic recording medium whose surface has been subjected to later-described activation treatment, and a variety of functional groups that are crosslinkable with the resist layer 14 (resist resin); examples include, for example, 4-methacryloxyethyl trimellitic anhydride, γ-glycidoxypropyloxyethyl trimellitic anhydride, γ-aminopropyloxyethyl trimellitic anhydride, and γ-chloropropyloxyethyl trimellitic anhydride.

By use of the interface binder of the present invention, adhesion between a laminate 10 for forming magnetic recording medium (subject to be processed) and resist layer 14 formed on the laminate 10 increases, and a thin layer of resist solution can be uniformly formed over the laminate by imparting of wettability to the laminate by means of resist solution for increased laminate coatability. In this way high-accuracy imprinting over a large area is made possible.

Meanwhile, by use of the interface binder of the present invention, the laminate and resist layer are more firmly bonded, which makes removal of residual pieces of the resist layer more difficult after patterning by etching or the like. To avoid this problem, compound(s) that can be removed by any of oxygen plasma treatment, oxygen ashing treatment and UV ozone treatment after patterning are selected as an interface binder. This makes the resist layer removable even when it has been made harder by curing.

Selection of such a compound that can be removed by any of oxygen plasma treatment, oxygen ashing treatment and UV ozone treatment (e.g., at least one of a silane coupling agent and carboxylic anhydride) as an interface binder can achieve, at the same time, both adhesion of the resist layer with respect to the laminate and resist layer removal property after patterning. Thus, the interface binder of the present invention can be suitably used in patterning of magnetic layer by means of nanoimprint lithography.

Hereinafter, the resist composition constituting the resist layer will be detailed.

The resist composition may be any of photocurable resin composition, thermosetting resin composition and thermoplastic resin composition, which will be described later; however, any resin composition can be suitably used. In addition, these resin compositions may be used in combination.

Among these compositions, photocurable resin compositions are employed that offer, for example, high optical transparency, excellent fine-pattern formability, excellent coatability and excellent other processing suitabilities before curing, and during or after curing, provide comprehensively excellent coating properties in terms of sensitivity (fast setting property), resolution, line-edge roughness property, coating strength, separation from mold, residual layer characteristics, etching resistance, low shrinkage, adhesion to substrate, and other aspects. These photocurable compositions can be widely used in photo-nanoimprint lithography.

Specifically, photocurable nanoimprint resist compositions, when combined with the interface binder, provide the following features in photo-nanoimprint lithography.

(1) High flowability of the resist composition solution at room temperature. Thus, the composition easily flows into cavities or concave portions of the mold. This eliminates defects (e.g., generation of bubbles), and residues of resist composition are less likely to remain at convex and concave portions of the mold after photocuring.

(2) Excellent mechanical strength of the cured layer, excellent adhesion between the coating and substrate, and excellent separation between the mold and coating are obtained. Thus, formation of excellent patterns is made possible since no pattern crumbling and/or surface disturbance due to edge chipping occur upon mold separation.

(3) Small volume reduction after photocuring and excellent mold transfer characteristics. Thus, the size and shape of fine pattern can be retained with accuracy.

(4) Excellent coating uniformity. Thus, the resist resin composition is suitable for application onto large-size substrates as well as for fine patterning.

(5) High photocuring rate. Thus, high productivity is obtained.

(6) Excellent etching accuracy and etching resistance. Thus, the cured resist composition can be suitably used as an etching resist for processing of substrate such as a magnetic layer.

(7) Excellent resist removal property after etching. Thus, no residual pieces of resist layer remain, making the cured resist composition suitable as an etching resist.

The nanoimprint resist composition contains 88% by mass to 99% by mass of a polymerizable unsaturated monomer, 0.1% by mass to 11% by mass of a photopolymerization initiator, and 0.001% by mass to 5% by mass of at least one of a fluorine surfactant, silicone surfactant and fluorine-silicone surfactant.

The polymerizable unsaturated monomer preferably contains a monofunctional polymerizable unsaturated monomer in an amount of 10% by mass or more, more preferably 15% by mass or more in the polymerizable unsaturated monomer. The monofunctional polymerizable unsaturated monomer contains in its molecule an ethylenically unsaturated bond-containing site and a site that contains at least one hetero atom (e.g., oxygen atom, nitrogen atom, and sulfur atom).

As the polymerizable unsaturated monomer, it is possible to employ a monofunctional polymerizable unsaturated monomer represented by any one of the following General Formulas (I) to (VIII).

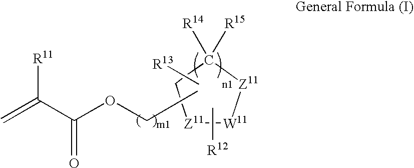

where R¹¹ represents a hydrogen atom or alkyl group which has 1 to 6 carbon atoms and which may form a ring; R¹², R¹³, R¹⁴ and R¹⁵ each represent any one of a hydrogen atom, alkyl group which has 1 to 6 carbon atoms and which may form a ring, and alkoxy group having 1 to 6 carbon atoms; n1 represents 1 or 2; ml represents any one of 0, 1 and 2; Z¹¹ represents an alkylene group having 1 to 6 carbon atoms, oxygen atom, or —NH—, with two Z¹¹s being the same or different; and W¹¹ represents —C(═O)— or —SO₂—, wherein R¹² and R¹³ may be joined together to form a ring, and R¹⁴ and R¹⁵ may be joined together to form a ring.

In the formula above, R¹¹ preferably represents a hydrogen atom or methyl group; R¹², R¹³, R¹⁴ and R¹⁵ each preferably represent any one of a hydrogen atom, methyl group, ethyl group, propyl group, butyl group, methoxy group and ethoxy group, more preferably any one of hydrogen atom and methyl group, most preferably hydrogen atom; ml preferably represents 0 or 1; Z¹¹ preferably represents any one of a methylene group, oxygen atom and —NH—, with at least one of two Z¹¹s being preferably oxygen atom; and W¹¹ preferably represents —C—(═O)—.

When n1 is 2 or greater, R¹⁴ and R¹⁵ may be the same or different.

Specific examples of the compounds represented by General Formula (I) are compounds of the following formulas (I-1) to (I-19).

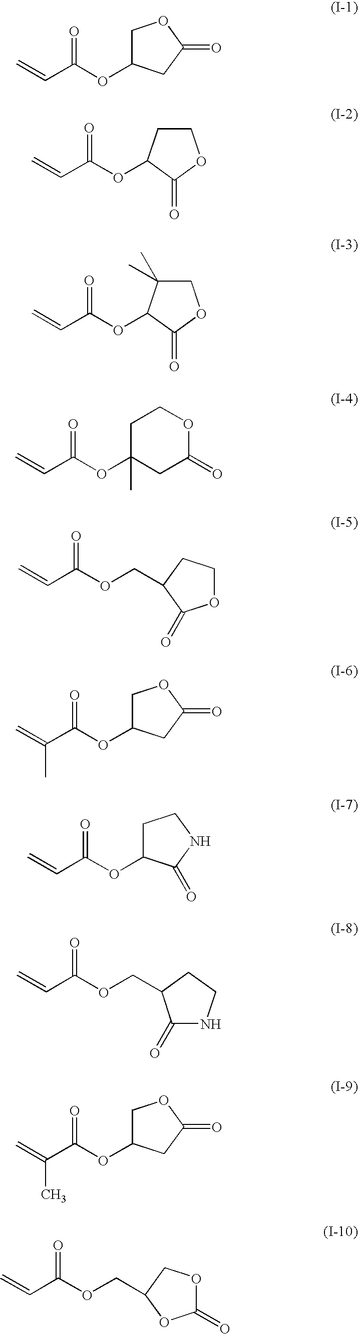

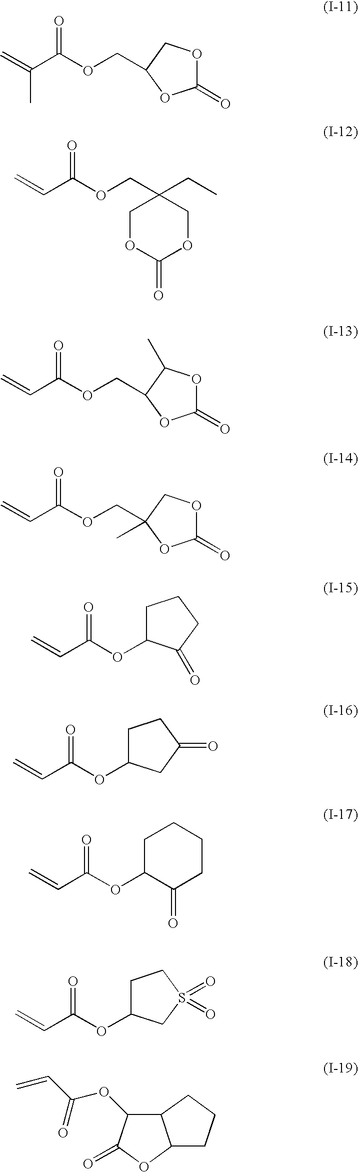

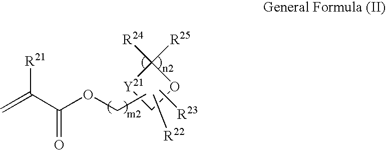

where R²¹ represents a hydrogen atom or alkyl group which has 1 to 6 carbon atoms and which may form a ring; R²², R²³, R²⁴ and R²⁵ each represent any one of a hydrogen atom, alkyl group which has 1 to 6 carbon atoms and which may form a ring, halogen atom, and alkoxy group having 1 to 6 carbon atoms; n2 represents any one of 1, 2 and 3; m2 represents any one of 0, 1 and 2; and Y²¹ represents an alkylene group having 1 to 6 carbon atoms or oxygen atom, wherein R²² and R²³ may be joined together to form a ring, and R²⁴ and R²⁵ may be joined together to form a ring.

In the formula above, R²¹ preferably represents a hydrogen atom or methyl group; R²², R²³, R²⁴ and R²⁵ each preferably represent any one of a hydrogen atom, methyl group, ethyl group, propyl group, butyl group, halogen atom, methoxy group and ethoxy group, more preferably any one of a hydrogen atom, methyl group, ethyl group, propyl group and butyl group, most preferably any one of a hydrogen atom, methyl group and ethyl group; n2 preferably represents 1 or 2; m2 preferably represents 0 or 1; and Y²¹ preferably represents methylene group or oxygen atom.

Specific examples of the compounds represented by General Formula (II) are compounds of the following formulas (II-1) to (II-9).

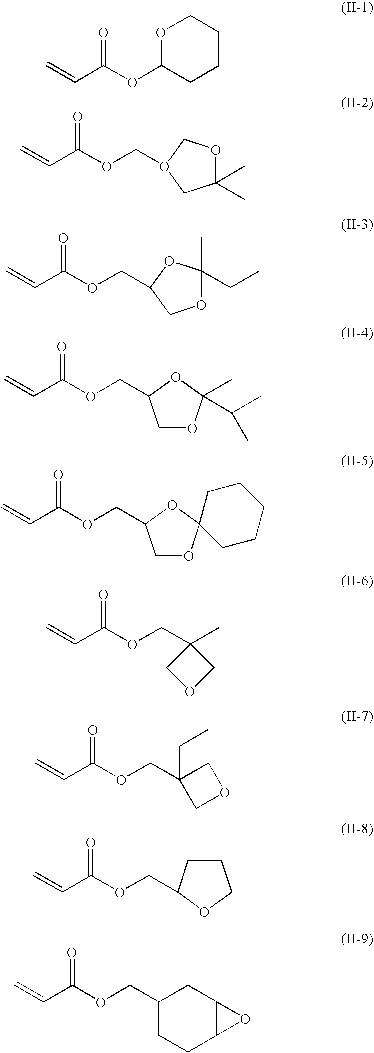

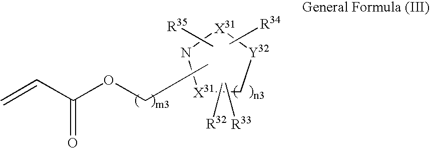

where R³², R³³, R³⁴ and R³⁵ each represent any one of a hydrogen atom, alkyl group which has 1 to 6 carbon atoms and which may form a ring, halogen atom, and alkoxy group having 1 to 6 carbon atoms; n3 represents any one of 1, 2 and 3; m3 represents any one of 0, 1 and 2; X³¹ represents —C(═O)— or alkylene group having 1 to 6 carbon atoms, with two X³¹s being the same or different; and Y³² represents an oxygen atom or alkylene group having 1 to 6 carbon atoms.

In the formula above, R³², R³³, R³⁴ and R³⁵ each preferably represent any one of a hydrogen atom, methyl group, ethyl group, propyl group, butyl group, halogen atom, methoxy group and ethoxy group, more preferably any one of hydrogen atom, methyl group, ethyl group and propyl group, most preferably hydrogen atom; n3 preferably represents 1 or 2; X³¹ preferably represents any one of —C(═O)—, methylene group and ethylene group; and Y³² preferably represents a methylene group or oxygen atom.

Specific examples of the compounds represented by General Formula (III) are compounds of the following formulas (III-1) to (III-11).

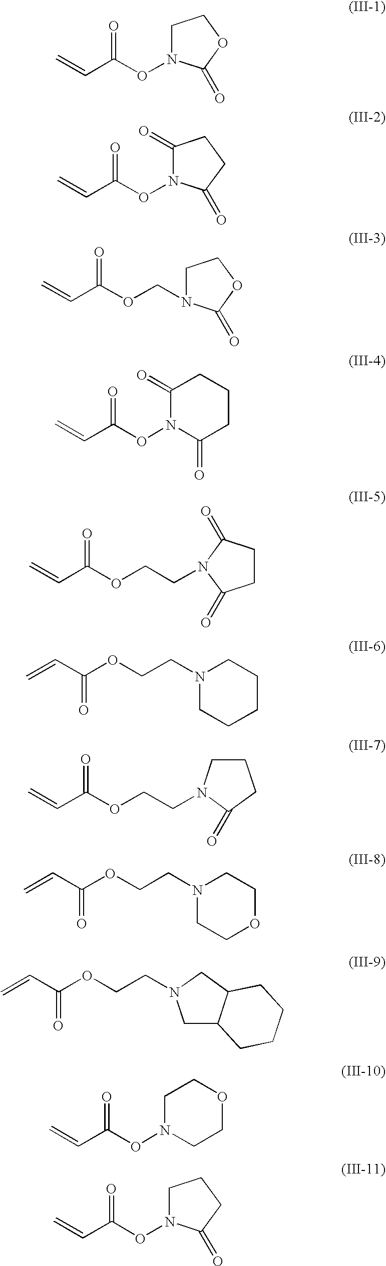

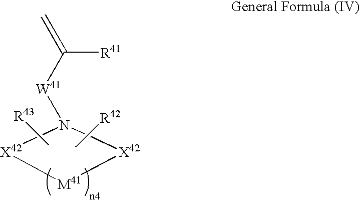

where R⁴¹ represents a hydrogen atom or alkyl group which has 1 to 6 carbon atoms and which may form a ring; R⁴² and R⁴³ each represent any one of an alkyl group which has 1 to 6 carbon atoms and which may form a ring, halogen atom, and alkoxy group having 1 to 6 carbon atoms; W⁴¹ represents a single bond or —C(═O)—; n4 represents any one of 2, 3 and 4; X⁴² represents —C(═O)— or alkylene group having 1 to 6 carbon atoms, with X⁴²s being the same or different; and M⁴¹ represents any one of a hydrocarbon linking group having 1 to 4 carbon atoms, oxygen atom and nitrogen atom, with M⁴¹s being the same or different.

In the formula above, R⁴¹ preferably represents a hydrogen atom or methyl group, more preferably hydrogen atom; R⁴² and R⁴³ each preferably represent any one of a hydrogen atom, methyl group, ethyl group, propyl group, butyl group, halogen atom, methoxy group and ethoxy group, more preferably any one of a hydrogen atom, methyl group and ethyl group, most preferably hydrogen atom; M⁴¹ preferably represents any one of a methylene group, ethylene group, propylene group and butylene group; and X⁴² preferably represents —C(═O)— or methylene group.

Specific examples of the compounds represented by General Formula (IV) are compounds of the following formulas (IV-1) to (IV-13).

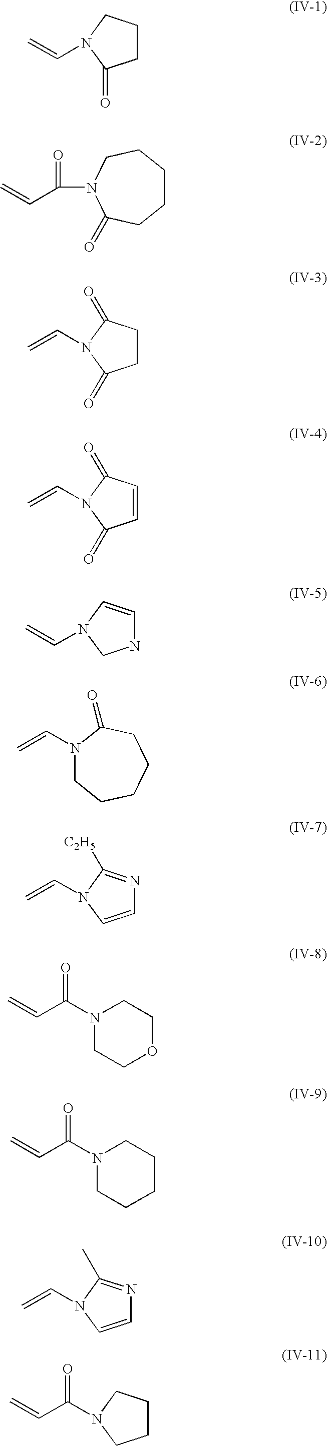

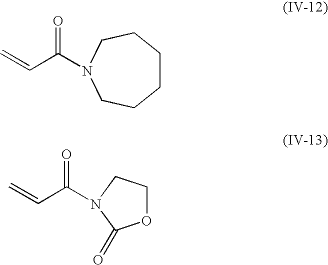

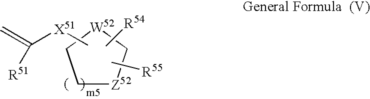

where R⁵¹ represents a hydrogen atom or alkyl group which has 1 to 6 carbon atoms and which may form a ring; Z52 represents any one of an oxygen atom, —CH═N′ and alkylene group having 1 to 6 carbon atoms; W⁵² represents an oxygen atom or alkylene group having 1 to 6 carbon atoms; R⁵⁴ and R⁵⁵ each represent any one of a hydrogen atom, alkyl group which has 1 to 6 carbon atoms and which may form a ring, halogen atom, and alkoxy group having 1 to 6 carbon atoms, with R⁵⁴ and R⁵⁵ optionally joined together to form a ring; X⁵¹ represents a single bond or X⁵¹ may not exist so that the double bond is directly bonded to the ring structure; m5 represents any one of 0, 1 and 2; and at least one of W⁵², Z⁵², R⁵⁴ and R⁵⁵ contains an oxygen atom or nitrogen atom.

In the formula above, R⁵¹ preferably represents a hydrogen atom or methyl group; Z⁵² preferably represents any one of an oxygen atom, —CH═N— and methylene group; W⁵² preferably represents a methylene group or oxygen atom; R⁵⁴ and R⁵⁵ each preferably represent any one of a hydrogen atom, methyl group, ethyl group, propyl group, butyl group, halogen atom, methoxy group and ethoxy group, more preferably any one of a hydrogen atom, methyl group and ethyl group, most preferably any one of a hydrogen atom and methyl group; and m5 preferably represents 1 or 2.

Specific examples of the compounds represented by General Formula (V) are compounds of the following formulas (V-1) to (V-8).

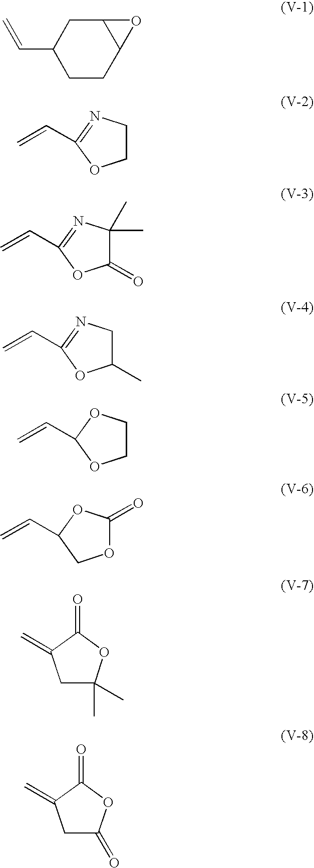

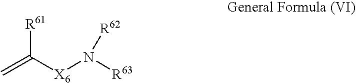

where R⁶¹ represents a hydrogen atom or alkyl group which has 1 to 6 carbon atoms and which may form a ring; R⁶² and R⁶³ each represent any one of a hydrogen atom, alkyl group which has 1 to 6 carbon atoms and which may form a ring, hydroxyalkyl group having 1 to 6 carbon atoms, (CH₃)₂N—(CH₂)ₘ₆— (where m6 represents any one of 1, 2 and 3), CH₃CO—(CR⁶⁴R⁶⁵)ₚ₆— (where R⁶⁴ and R⁶⁵ each represent a hydrogen atom or alkyl group which has 1 to 6 carbon atoms and which may form a ring, and p6 represents any one of 1, 2 and 3), (CH₃)₂—N—(CH₂)ₚ₆— (where p6 represents any one of 1, 2 and 3) and group having ═CO, and R⁶² and R⁶³ cannot be hydrogen atom at the same time; and X⁶ represents any one of —CO—, —COCH₂—, —COCH₂CH₂—, —COCH₂CH₂CH₂—, —COOCH₂CH₂—.

In the formula above, R⁶¹ preferably represents a hydrogen atom or methyl group, more preferably represents a hydrogen atom; R⁶² and R⁶³ each preferably represent any one of a hydrogen atom, methyl group, ethyl group, propyl group, hydroxyethyl group, (CH₃)₂—N—(CH₂)ₘ₆—, CH₃CO—(CR⁶⁴R⁶⁵)ₚ₆—, (CH₃)₂—N—(CH₂)ₚ₆—, and group having ═CO; and R⁶⁴ and R⁶⁵ each preferably represent any one of a hydrogen atom, methyl group, ethyl group and propyl group.

Specific examples of the compounds represented by General Formula (VI) are compounds of the following formulas (VI-1) to (VI-10).

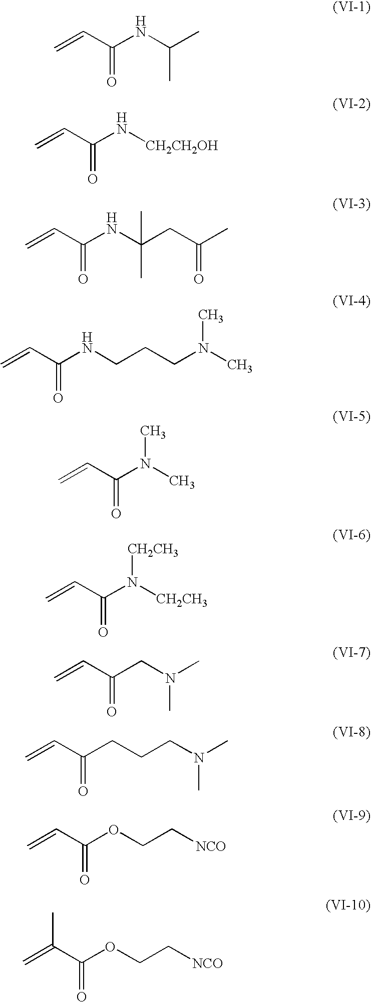

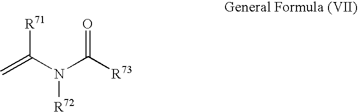

where R⁷¹ and R⁷² each represent a hydrogen atom or alkyl group which has 1 to 6 carbon atoms and which may form a ring; and R⁷³ represents a hydrogen atom or alkyl group which has 1 to 6 carbon atoms and which may form a ring.

In the formula above, R⁷¹ and R⁷² each preferably represents a hydrogen atom or methyl group, and R⁷³ preferably represents any one of a hydrogen atom, methyl group and ethyl group.

Specific examples of the compounds represented by General Formula (VII) are compounds of the following formulas (VII-1) to (VII-3).

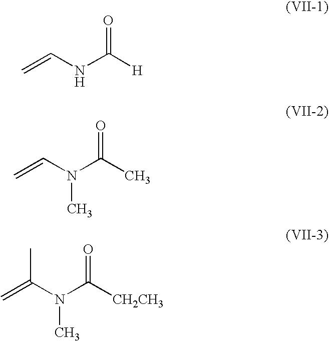

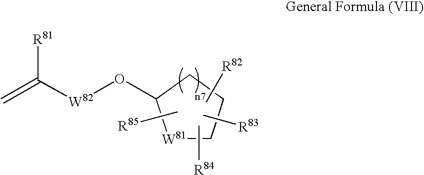

where R⁸¹ represents any one of a hydrogen atom, alkyl group which has 1 to 6 carbon atoms and which may form a ring, and hydroxyalkyl group having 1 to 6 carbon atoms; R⁸², R⁸³, R⁸⁴ and R⁸⁵ each represent any one of a hydrogen atom, hydroxyl group, alkyl group which has 1 to 6 carbon atoms and which may form a ring, and hydroxyalkyl group having 1 to 6 carbon atoms, with at least two of R⁸², R⁸³, R⁸⁴ and R⁸⁵ optionally jointed together to form a ring; W⁸¹ represents any one of an alkylene group having 1 to 6 carbon atoms, —NH—, —N—CH₂—, and —N—C₂H₄—; and W⁸² represents a single bond or —C(═O)—, wherein when W⁸² is a single bond, neither of R⁸², R⁸³, R⁸⁴ and R⁸⁵ is not a hydrogen atom; and n7 represents an integer from 0 to 8.

In the formula above, R⁸¹ preferably represents a methyl group or hydroxymethyl group, more preferably represents a hydrogen atom; R⁸², R⁸³, R⁸⁴ and R⁸⁵ preferably represents any one of a hydrogen atom, hydroxyl group, methyl group, ethyl group, hydroxymethyl group, hydroxyethyl group, propyl group and butyl group; and W⁸¹ preferably represents any one of —CH₂—, —NH—, —N—CH₂— and —N—C₂H₄—.

Specific examples of the compounds represented by General Formula (VIII) are compounds of the following formulas (VIII-1) to (VIII-15).

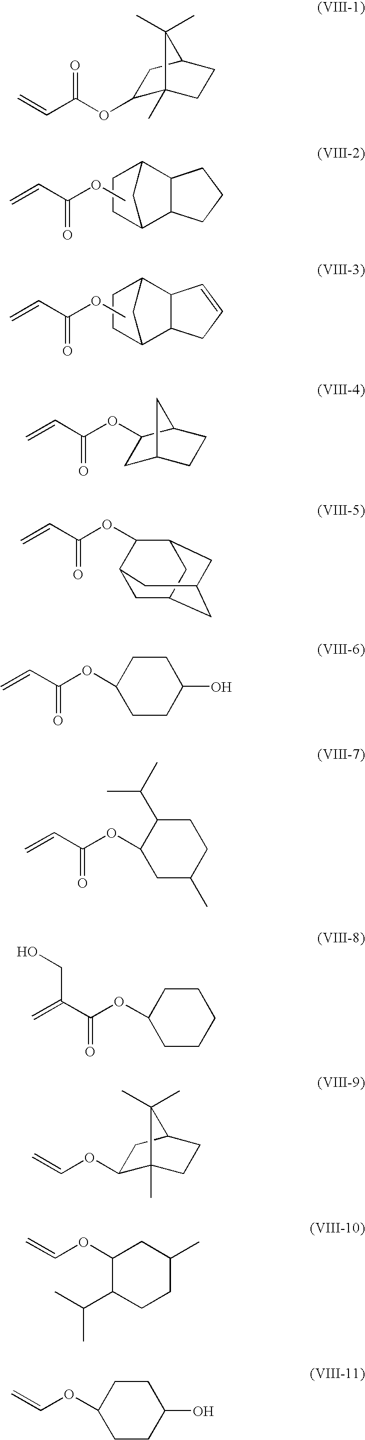

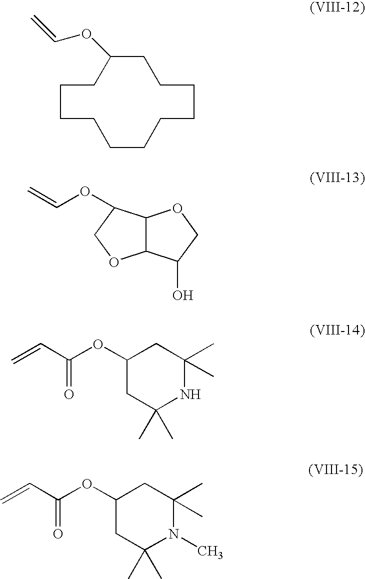

In addition to the above polymerizable unsaturated monomer, the resist composition may contain a polymerizable unsaturated monomer having an ethynically unsaturated bond-containing site, and at least one of a silicon atom and phosphorous atom (hereinafter may be referred to as “second polymerizable unsaturated monomer”). The second polymerizable unsaturated monomer may be a monofunctional polymerizable unsaturated monomer or polyfunctional polymerizable unsaturated monomer.

As the second polymerizable unsaturated monomer, the following compounds (IX-6) to (IX-23) can be employed.

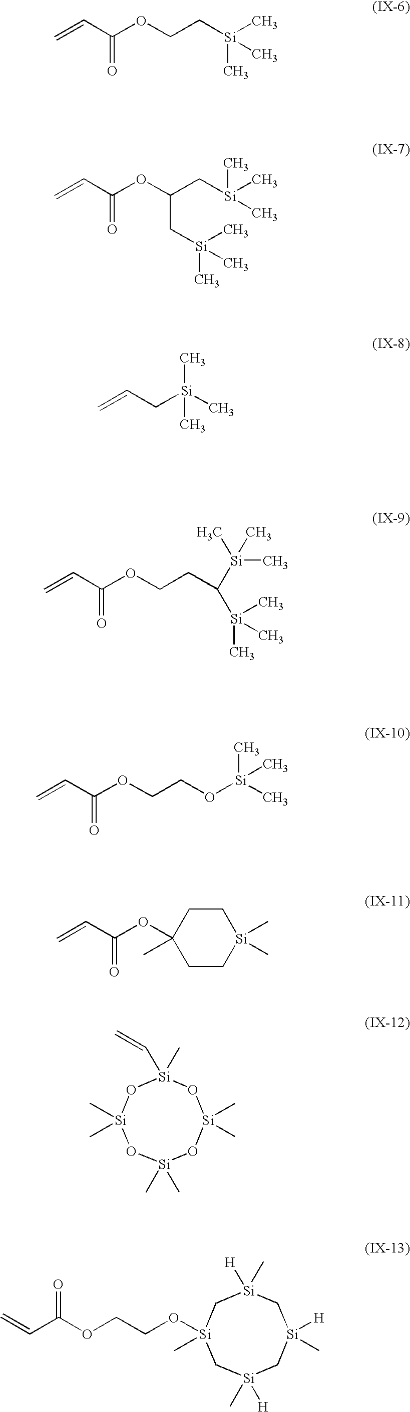

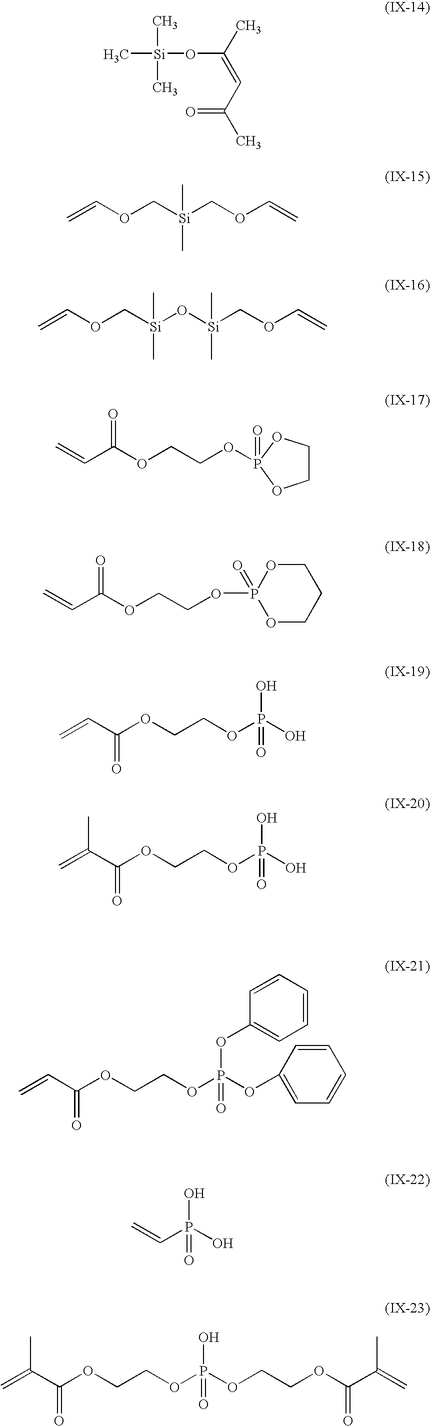

The nanoimprint resist composition contains as an essential ingredient a monofunctional polymerizable unsaturated monomer that has in its molecule an ethylenically unsaturated bond-containing site and a site containing an oxygen atom, nitrogen atom, or sulfur atom. For the purpose of improving film strength, film flexibility etc., the nanoimprint resist composition may further contain in combination any of the following polymerizable unsaturated monomers each having an ethylenically unsaturated bond-containing group, or monofunctional polymerizable unsaturated monomers.

Specific examples of such compounds that can be used in combination include, for example, 2-acryloyloxyethyl phthalate, 2-acryloyloxy-2-hydroxyethyl phthalate, 2-acryloyloxyethyl hexahydrophthalate, 2-acryloyloxypropyl phthalate, 2-ethyl-2-butylpropandiol acrylate, 2-ethylhexyl (meth)acrylate, 2-ethylhexylcarbitol (meth)acrylate, 2-hydroxybutyl (meth)acrylate, 2-hydroxyethyl (meth)acrylate, 2-hydroxypropyl (meth)acrylate, 2-methoxyethyl (meth)acrylate, 3-methoxybutyl (meth)acrylate, 4-hydroxybutyl (meth)acrylate, acrylic acid dimer, aliphatic epoxy (meth)acrylate, benzyl (meth)acrylate, butanediol mono(meth)acrylate, butoxyethyl (meth)acrylate, butyl (meth)acrylate, cetyl (meth)acrylate, ethyleneoxide (hereinafter abbreviated as “EO”)-modified cresol (meth)acrylate, dipropylene glycol (meth)acrylate, ethoxylated phenyl (meth)acrylate, ethyl (meth)acrylate, isoamyl (meth)acrylate, isobutyl (meth)acrylate, isooctyl (meth)acrylate, isomyristyl (meth)acrylate, lauryl (meth)acrylate, methoxydipropylene glycol (meth)acrylate, methoxytripropylene glycol (meth)acrylate, methoxypolyethylene glycol (meth)acrylate, methoxytriethylene glycol (meth)acrylate, methyl (meth)acrylate, neopentyl glycol benzoate (meth)acrylate, nonylphenoxypolyethylene glycol (meth)acrylate, nonylphenoxypolypropylene glycol (meth)acrylate, octyl (meth)acrylate, para-cumylphenoxyethylene glycol (meth)acrylate, epichlorohydrin (hereinafter abbreviated as “ECH”)-modified phenoxy acrylate, phenoxyethyl (meth)acrylate, phenoxydiethylene glycol (meth)acrylate, phenoxyhexaethylene glycol (meth)acrylate, phenoxytetraethylene glycol (meth)acrylate, polyethylene glycol (meth)acrylate, polyethylene glycol-polypropylene glycol (meth)acrylate, polypropylene glycol (meth)acrylate, stearyl (meth)acrylate, EO-modified succinic acid (meth)acrylate, tert-butyl (meth)acrylate, tribromophenyl (meth)acrylate, EO-modified tribromophenyl (meth)acrylate, tridodecyl (meth)acrylate, p-isopropenylphenol, styrene, α-methyl styrene, acrylonitrile, vinyl carbazole, isocyanate alkyl (meth)acrylates such as isocyanate methyl (meth)acrylate, isocyanate ethyl (meth)acrylate, isocyanate n-propyl (meth)acrylate, isocyanate isopropyl (meth)acrylate, isocyanate n-butyl (meth)acrylate, isocyanate isobutyl (meth)acrylate, isocyanate sec-butyl (meth)acrylate and isocyanate tert-butyl (meth)acrylate, and (meth)acryloyl alkyl isocyanates such as (meth)acryloyl methyl isocyanate, (meth)acryloyl ethyl isocyanate, (meth)acryloyl n-propyl isocyanate, (meth)acryloyl isopropyl isocyanate, (meth)acryloyl n-butyl isocyante, (meth)acryloyl isobutyl isocyanate, (meth)acryloyl sec-butyl isocyanate and (meth)acryloyl tert-butyl isocyanate.

The nanoimprint resist composition preferably contains a polyfunctional polymerizable unsaturated monomer having two or more ethylenically unsaturated bond-containing groups.

Examples of bifunctional polymerizable unsaturated monomers include, for example, diethylene glycol monoethylether (meth)acrylate, dimethylol dicyclopentane di(meth)acrylate, di(meth)acrylated isocyanurate, 1,3-butylene glycol di(meth)acrylate, 1,4-butanediol di(meth)acrylate, EO-modified 1,6-hexanediol di(meth)acrylate, ECH-modified 1,6-hexanediol di(meth)acrylate, allyloxypolyethylene glycol acrylate, 1,9-nonanediol di(meth)acrylate, EO-modified bisphenol A di(meth)acrylate, propylene oxide (hereinafter abbreviated as “PO”)-modified bisphenol A di(meth)acrylate, modified bisphenol A di(meth)acrylate, EO-modified bisphenol F di(meth)acrylate, ECH-modified hexahydrophthalic diacrylate, neopentyl glycol hydroxypivalate di(meth)acrylate, neopentylglycol di(meth)acrylate, EO-modified neopentylglycol diacrylate, PO-modified neopentyl glycol diacrylate, caprolactone-modified neopentyl glycol hydroxypivalate, stearic acid-modified pentaerythritol di(meth)acrylate, ECH-modified phthalic acid di(meth)acrylate, poly(ethylene glycol-tetramethylene glycol) di(meth)acrylate, poly(propylene glycol-tetramethylene glycol) di(meth)acrylate, polyester (di)acrylate, polyethylene glycol di(meth)acrylate, polypropylene glycol di(meth)acrylate, ECH-modified polypropylene glycol di(meth)acrylate, silicone di(meth)acrylate, triethylene glycol di(meth)acrylate, tetraethylene glycol di(meth)acrylate, tricyclodecanedimethanol (di)acrylate, neopentyl glycol-modified trimethylolpropane di(meth)acrylate, tripropylene glycol di(meth)acrylate, EO-modified tripropylene glycol di(meth)acrylate, triglycerol di(meth)acrylate, dipropylene glycol di(meth)acrylate, divinylethylene urea, and divinylpropylene urea.

Among these compounds, for example, 1,9-nonanediol di(meth)acrylate, tripropylene glycol di(meth)acrylate, tetraethylene glycol di(meth)acrylate, neopentyl glycol hydroxypivalate di(meth)acrylate, and polyethylene glycol di(meth)acrylate can be suitably employed.

Examples of polyfunctional polymerizable unsaturated monomers having three or more ethylenically unsaturated bond-containing groups include, for example, ECH-modified glycerol tri(meth)acrylate, EO-modified glycerol tri(meth)acrylate, PO-modified glycerol tri(meth)acrylate, pentaerythritol triacrylate, EO-modified phosphoric acid triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl) isocyanurate, dipentaerythritol hexa(meth)acrylate, caprolactone-modified dipentaerythritol hexa(meth)acrylate, dipentaerythritol hydroxypenta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxytetra(meth)acrylate, and pentaerythritol tetra(meth)acrylate.

Among these compounds, for example, EO-modified glycerol tri(meth)acrylate, PO-modified glycerol tri(meth)acrylate, trimethylolpropane tri(meth)acrylate, EO-modified trimethylolpropane tri(meth)acrylate, PO-modified trimethylolpropane tri(meth)acrylate, dipentaerythritol hexa(meth)acrylate, pentaerythritol ethoxytetra(meth)acrylate, and pentaerythritol tetra(meth)acrylate can be suitably employed.

When a compound is used that has two or more photopolymerizable functional groups in one molecule, it results in introduction of great amounts of photopolymerizable functional groups in the composition and therefore the crosslink density greatly increases in the composition. Thus, it produces the high effect of improving various physical properties of the cured composition and etching resistance increases, thereby reducing the likelihood of deformation, loss, or damage of the fine concave-convex pattern.

For the purpose of further increasing the crosslink density, the nanoimprint resist composition may additionally contain a polyfunctional oligomer and/or polymer that has a higher molecular weight than any of the above polyfunctional polymerizable unsaturated monomers in amounts within which the present invention is operable. Examples of polyfunctional oligomers that can undergo photopolymerization include, for example, various acrylate oligomers such as polyester acrylate, polyurethane acrylate, polyether acrylate and polyepoxy acrylate, and oligomers or polymers that have bulky structure such as phosphazene skeleton, adamantane skeleton, cardo skeleton, norbornene skeleton or novolac skeleton.

As the polymerizable unsaturated monomers, it is also possible to employ compounds having an oxysilane ring. Examples of compounds having an oxysilane ring include, for examples, polyglycidyl esters of polybasic acids, polyglycidyl ethers of polyalcohols, polyglycidyl ethers of polyoxyalkylene glycols, polyglycidyl ethers of aromatic polyols, hydrogenated compounds of polyglycidyl ethers of aromatic polyols, urethane polyepoxy compounds and epoxylated polybutadiens. These compounds may be used singly or in combination.

Preferable examples of the epoxy compounds include, for example, bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, hydrogenated bisphenol A diglycidyl ether, hydrogenated bisphenol F diglycidyl ether, hydrogenated bisphenol S diglycidyl ether, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ether; polyglycidyl ethers of polyether polyols obtained by adding one or more alkylene oxides to aliphatic polyols such as ethylene glycol, propylene glycol or glycerin; diglycidyl esters of long-chain aliphatic dibasic acids; monoglycidyl ethers of higher aliphatic alcohols; monoglycidyl ethers of phenol, cresol, butyl phenol, or polyether alcohols obtained by adding alkylene oxides to them; and glycidyl esters of higher fatty acids.

Among these compounds, bisphenol A diglycidyl ether, bisphenol F diglycidyl ether, hydrogenated bisphenol A diglycidyl ether, hydrogenated bisphenol F diglycidyl ether, 1,4-butandiol diglycidyl ether, 1,6-hexanediol diglycidyl ether, glycerin triglycidyl ether, trimethylolpropane triglycidyl ether, neopentyl glycol diglycidyl ether, polyethylene glycol diglycidyl ether, and polypropylene glycol diglycidyl ether are most preferable.

Examples of commercially available products suitably employed as glycidyl group-containing compounds include, for example, UR-6216 (available from Union Carbide Corporation); GLYCIDOL, AOEX24, and CYCLOMER A200 (available from Daicel Chemical Industries, Ltd.); EPICOAT 828, EPICOAT 812, EPICOAT 1031, EPICOAT 872 and EPICOAT 508 (available from Yuka Shell Epoxy Co., Ltd.); and KRM-2400, KRM-2410, KRM-2408, KRM-2490, KRM-2720 and KRM-2750 (available from Asahi Denka Kogyo K.K.). These products may be used singly or in combination.

The method of production of these oxysilane ring-containing compounds is not specifically limited; however, for example, these compounds can be prepared with reference to, for example, Organic Synthesis II (in Experimental Chemistry Series 4^{th} ed., Vol. 20, pp. 213-(1992), Japan Chemical Society Ed., Maruzen Publ. Co.), Ed, by Alfred Hasfner, The chemistry of heterocyclic compounds—Small Ring Heterocycles part3 Oxiranes, John & Wiley and Sons, An International Publication, New York, 1985, Yosimura, “Adhesion”, Vol. 29, No.12, pp. 32 (1985), Yoshimura, “Adhesion”, Vol. 30, No.5, pp. 42 (1986), Yoshimura “Adhesion”, Vol. 30, No.7, pp. 42 (1986), JP-A 11-100378, and Japanese Patent (JP-B) Nos. 2906245 and 2926262.

Vinyl ether compounds may be used in combination as polymerizable compounds and can be appropriately selected according to the intended purpose; examples thereof include, for example, 2-ethylhexyl vinyl ether, butandiol-1,4-divinyl ether, diethylene glycol monovinyl ether, ethylene glycol divinyl ether, triethylene glycol divinyl ether, 1,2-propanediol divinyl ether, 1,3-propanediol divinyl ether, 1,3-butandiol divinyl ether, 1,4-butandiol divinyl ether, tetramethylene glycol divinyl ether, neopentyl glycol divinyl ether, trimethylolpropane trivinyl ether, trimethylolethane trivinyl ether, hexanediol divinyl ether, tetraethylene glycol divinyl ether, pentaerythritol divinyl ether, pentaerythritol trivinyl ether, pentaerythritol tetravinyl ether, sorbitol tetravinyl ether, sorbitol pentavinyl ether, ethylene glycol diethylene vinyl ether, triethylene glycol diethylene vinyl ether, ethylene glycol dipropylene vinyl ether, triethylene glycol diethylene vinyl ether, trimethylolpropane triethylene vinyl ether, trimethylolpropane diethylene vinyl ether, pentaerythritol diethylene vinyl ether, pentaerythritol triethylene vinyl ether, pentaerythritol tetraethylene vinyl ether, 1,1,1-tris [4-(2-vinyloxyethoxy)phenyl]ethane, and bisphenol A divinyloxyethyl ether.

These vinyl ether compounds can be prepared for instance by the method described in Stephen. C. Lapin, Polymers Paint Colour Journal. 179(4237), 321(1988), i.e., by reaction of acetylene with polyol or polyphenol or by reaction of halogenated alkyl vinyl ether with polyol or polyphenol. The vinyl ether compounds can be used singly or in combination.

Examples of the polymerizable compounds include, for example, styrene derivatives, and examples thereof include, for example, styrene, p-methylstyrene, p-methoxystyrene, β-methylstyrene, p-methyl-β-methylstyrene, α-methylstyrene, p-methoxy-β-methylstyrene, and p-hydroxystyrene. Examples of vinylnaphthalene /derivatives include, for example, 1-vinylnaphthalene, α-methyl-1-vinylnaphthalene, β-methyl-1-vinylnaphthalene, 4-mehtyl-1-vinylnaphthalene, and 4-methoxy-1-vinylnaphthalene.

Moreover, for the purpose of improving separation from the mold and/or coatability, fluorine atom-containing compounds can be used in combination; examples thereof include, for example, trifluoroethyl (meth)acrylate, pentafluoroethyl (meth)acrylate, (perfluorobutyl)ethyl (meth)acrylate, perfluorobutyl-hydroxypropyl (meth)acrylate, (perfluorohexyl)ethyl (meth)acrylate, octafluoropentyl (meth)acrylate, perfluorooctylethyl (meth)acrylate, and tetrafluoropropyl (meth)acrylate.

As the polymerizable compounds, propenyl ethers and butenyl ethers can be added. For example, 1-dodecyl-1-propenyl ether, 1-dodecyl-1-butenyl ether, 1-butenoxymethyl-2-norbornene, 1-4-di(1-butenoxy)butane, 1,10-di(1-butenoxy)decane, 1,4-di(1-butenoxymethyl)cyclohexane, diethylene glycol di(1-butenyl) ether, 1,2,3-tri(1-butenoxy)propane, and propenyl ether propylene carbonate, and the like can be suitably employed.

The preferred manner in which the polymerizable unsaturated monomer is blended in the nanoimprint resist composition will be described below.

The nanoimprint resist composition is first required that it ensure both productivity and formability upon imprinting, particularly fine patterning capability required for patterning of magnetic layer, and etching resistance for patterning of the magnetic layer by use of the patterned resist layer. It is preferable that the resist composition be of low viscosity to ensure high formability and productivity upon fine pattern transfer, have a high carbon density and crosslink density to ensure excellent etching resistance in dry etching which is particularly advantageous in terms of fine patterning capability, and have a high resist layer strength after pattern formation as well as high adhesion to a laminate for forming magnetic recording medium in order to ensure high fine pattern imprint accuracy. Furthermore, it is preferable that the resist composition offer excellent separation from the mold.

It is preferable to introduce a ring structure to increase carbon density. It is necessary to employ a polyfunctionalized monomer and to increase the post-curing crosslinking or polymerization degree in order to increase the substantive crosslink density for increased resist layer strength.

A monomer that has an introduced ring structure generally has a bulky structure, and when it is polyfunctionalized for increased crosslink density, the crosslinking reaction does not proceed further at a later stage and consequently the polymerization degree decreases. Therefore, it becomes difficult to ensure both etching resistance and pattern strength that enables fine pattern formation. In addition, since the resist layer before curing offers a high viscosity in this case, it becomes difficult to ensure both formability and productivity.

As a resist having an introduced ring, novolac polymers are generally known. These polymers have a high ring structure content and thus have a structure that is advantageous in terms of etching resistance. However, since they are polymer materials, the film viscosity is high and the polymerization degree does not raises to a sufficient level. Thus, novolac polymers cannot ensure formability, fine pattern strength, and etching resistance.

For these reasons, the nanoimprint resist composition preferably contains as an essential ingredient a monofunctional polymerizable unsaturated monomer having a ring structure, and additionally contains a polyfunctional polymerizable unsaturated monomer.

The monofunctional polymerizable unsaturated monomer having a ring structure is effective in lowering the viscosity of the nanoimprint resist composition and is added in an amount of 10% by mass or more based on the total amount of polymerizable compounds for the purpose of ensuring formability and etching resistance; preferably, it is added in an amount of 10% by mass to 80% by mass, more preferably 20% by mass to 70% by mass, and most preferably 30% by mass to 60% by mass.

It is preferable that the amount of the monofunctional polymerizable unsaturated monomer having a ring structure be 80% by mass or less since the mechanical strength and etching resistance of the cured film obtained by curing the nanoimprint resist composition tend to increase. Meanwhile, it is preferable that the added amount of the monofunctional polymerizable unsaturated monomer having a ring structure be 10% by mass or more based on the total amount of polymerizable compounds, since by doing so it is possible to reduce the viscosity of the resist composition.

The monomer having two unsaturated bond-containing groups (bifunctional polymerizable unsaturated monomer) is preferably added in an amount of 90% by mass or less, more preferably 80% by mass or less, and most preferably 70% by mass or less, based on the total amount of polymerizable compounds. The proportion of the monofunctional and bifunctional polymerizable unsaturated monomers is preferably 1% by mass to 95% by mass, more preferably 3% by mass to 95% by mass, and most preferably 5% by mass to 90% by mass, based on the total amount of polymerizable compounds. The proportion of a polyfunctional polymerizable unsaturated monomer having three or more unsaturated bond-containing groups is preferably 80% by mass or less, more preferably 70% by mass or less, and most preferably 60% by mass or less, based on the total amount of polymerizable unsaturated monomers, whereby the viscosity of the resist composition can be reduced.

In particular, the nanoimprint resist composition preferably has a polymerizable compound component that consists of 10% by mass to 80% by mass of a monofunctional polymerizable unsaturated monomer, 1% by mass to 60% by mass of a bifunctional polymerizable unsaturated monomer, and 1% by mass to 60% by mass of a polyfunctional polymerizable unsaturated monomer having three or more unsaturated bond-containing groups; more preferably, the polymerizable compound component consists of 15% by mass to 70% by mass of a monofunctional polymerizable unsaturated monomer, 2% by mass to 50% by mass of a bifunctional polymerizable unsaturated monomer, and 2% by mass to 50% by mass of a polyfunctional polymerizable unsaturated monomer having three or more unsaturated bond-containing groups.

In addition, the nanoimprint resist composition may further contain a polymerizable unsaturated monomer that has a site having at least one ethynically unsaturated bond and at least one of a silicon atom and phosphorous atom (second polymerizable unsaturated monomer). The second polymerizable unsaturated monomer is generally added for the purpose of improving mold separation and adhesion to substrate, and is added in an amount of 0.1% by mass based on the total amount of polymerizable compounds; preferably, it is added in an amount of 0.2% by mass to 10% by mass, more preferably 0.3% by mass to 7% by mass, and most preferably 0.5% by mass to 5% by mass. The number of sites having an ethylenically unsaturated bond, i.e., the number of functional groups, is preferably 1 to 3.

The water content of the nanoimprint resist composition when prepared is preferably 2.0% by mass or less, more preferably 1.5% by mass or less, and most preferably 1.0% by mass or less. Setting the water content when prepared to 2.0% by mass or less further increases the storage stability of the nanoimprint resist composition.

In addition, the nanoimprint resist composition can be prepared as an organic solvent solution by use of organic solvent. Organic solvents that can be suitably used for the nanoimprint resist composition are solvents generally used for photo-nanoimprint lithography curable compositions and photoresists, and are not specifically limited as long as they are capable of dissolving and uniformly dispersing compounds while being not reacted with them.

Examples of the organic solvents include, for example, alcohols such as methanol and ethanol; ethers such as tetrahydrofuran; glycol ethers such as ethylene glycol monomethyl ether, ethylene glycol dimethyl ether, ethylene glycol methylethyl ether, and ethylene glycol monoethyl ether; ethylene glycol alkyl ether acetates such as methyl cellosolve acetate, and ethyl cellosolve acetate; diethylene glycols such as diethylene glycol monomethyl ether, diethylene glycol diethyl ether, diethylene glycol dimethyl ether, diethylene glycol ethylmethyl ether, diethylene glycol monoethyl ether, and diethylene glycol monobutyl ether; propylene glycol alkyl ether acetates such as propylene glycol methyl ether acetate, and propylene glycol ethyl ether acetate; aromatic hydrocarbons such as toluene and xylene; ketones such as acetone, methyl ethyl ketone, cyclohexanone, 4-hydroxy-4-methyl-2-pentanone, and 2-heptanone; and esters such as ethyl 2-hydroxypropionate, methyl 2-hydroxy-2-methylpropionate, ethyl 2-hydroxy-2-methylpropionate, ethyl ethoxyacetate, ethyl hydroxyacetate, methyl 2-hydroxy-2-methylbutanoate, methyl 3-methoxypropionate, ethyl 3-methoxypropionate, methyl 3-ethoxypropionate, ethyl 3-ethoxypropionate, ethyl acetate, butyl acetate, and lactic acid esters such as methyl lactate and ethyl lactate.

In addition, it is possible to add high-boiling point solvents such as N-methylformamide, N,N-dimethylformamide, N-methylformanilide, N-methylacetamide, N,N-dimethylacetamide, N-methylpyrrolidone, dimethylsulfoxide, benzylethyl ether, dihexyl ether, acetonylacetone, isophorone, caproic acid, caprylic acid, 1-octanol, 1-nonanol, benzylalcohol, benzyl acetate, ethyl benzoate, diethyl oxalate, diethyl maleate, γ-butylolactone, ethylene carbonate, propylene carbonate, and phenylcellosolve acetate. These compounds may be used singly or in combination.

Among these, methoxypropylene glycol acetate, ethyl 2-hydroxypropionate, methyl 3-methoxypropionate, ethyl 3-ethoxypropionate, ethyl lactate, cyclohexanone, methyl isobutyl ketone, 2-heptanone, and the like are most preferable.

The nanoimprint resist composition may contain a photopolymerization initiator. Such a photopolymerization initiator makes up 0.1% by mass to 11% by mass, preferably 0.2% by mass to 10% by mass, and most preferably 0.3% by mass to 10% by mass of the entire composition. Note, however, that when additional photopolymerization initiators are used in combination, the total amount should fall within these ranges.

When the proportion of the photopolymerization initiator is less than 0.1% by mass, it undesirably results in poor sensitivity (fast setting capability), poor resolution, poor line-edge roughness property, and poor coat strength. When the proportion of the photopolymerization initiator is greater than 11% by mass, it undesirably results in poor light transmittance, poor coloring, and poor handleability. Various studies have been made as to preferable added amounts of at least one of the photopolymerization initiator and photoacid generator in an inkjet composition or liquid crystal display color filter composition, which contain at least one of dye and pigment; however, no report has been made so far concerning such preferable added amounts. More specifically, in a system where at least one of dye and pigment is added, they may act as a radical trapping agent and thereby affect photopolymerization capability and sensitivity. In view of this, the added amount of a photopolymerization initiator is optimized in such applications. On the other hand, the nanoimprint resist composition does not contain at least one of dye and pigment as an essential ingredient, and the optimal added amount range of photopolymerization initiator may differ from those for inkjet compositions, liquid crystal display color filter compositions and the like.

Such a photopolymerization initiator is added that is activated by the employed light and produces appropriate active species. The photopolymerization initiators may be used singly or in combination.

As radical polymerization initiators as the above photopolymerization initiators, for example, commercially available initiators can be employed; examples thereof include, for example, IRGACURE® 2959 (1-[4-(2-hydroxyethoxy)phenyl]-2-hydroxy-2-methyl-1-propane-1-one), IRGACURE® 184 (1-hydroxycyclohexyl phenyl ketone), IRGACURE® 500 (1-hydroxycyclohexyl phenyl ketone, benzophenone), IRGACURE® 651 (2,2-dimethoxy-1,2-diphenylethane-1-one), IRGACURE® 369 (2-benzyl-2-dimethylamino-1-(4-morpholinophenyl)butanone-1), IRGACURE® 907 (2-methyl-1[4-methylthiophenyl]-2-morpholinopropane-1-one), IRGACURE® 819 (bis(2,4,6-trimethylbenzoyl)-phenylphosphine oxide, IRGACURE® 1800 (bis(2,6-dimethoxybenzoyl)-2,4,4-trimethyl-pentylphosphine oxide, 1-hydroxy-cyclohexyl phenyl ketone), a mixture of bis(2,6-dimethoxybenzoyl)-2,4,4-trimethyl-pentylphosphine oxide and 2-hydroxy-2-methyl-1-phenyl-1-propane-1-one, IRGACURE® OXE01 (1,2-octanedione, 1-[4-(phenylthio)phenyl]-2-(O-benzoyloxime), DAROCUR® 1173 (2-hydroxy-2-methyl-1-phenyl-1-propane-1-one), DAROCUR® 1116, 1398, 1174 and 1020, and CGI242 (ethanone, 1-[9-ethyl-6-(2-methylbenzoyl)-9H-carbazole-3-yl]-1-(O-acethyloxime) available from Chiba Specialty Chemicals Inc., LUCIRIN TPO (2,4,6-trimethylbenzoyldiphenylphosphine oxide) and LUCIRIN TPO-L (2,4,6-trimethylbenzoylphenylethoxyphosphine oxide) available from BASF Corporation, ESACURE 1001M (1-[4-benzoylphenylsulfanyl]phenyl)-2-methyl-2-(4-methylphenylsulfonyl)propane-1-one) available from Nihon Siberhegner K.K., ADEKAOPTOMER® N-1414 (carbozole/phenone), ADEKAOPTOMER® N-1717 (acrydine) and ADEKAOPTOMER® N-1606 (triazine) available from Asahi Denka Kogyo Co., Ltd, TFE-Triazine (2-[2-(furan-2-yl)vinyl]-4,6-bis(trichloromethyl)-1,3,5-triazine), TME-Triazine (2-[2-(5-methylfuran-2-yl)vinyl]-4,6-bis(trichloroethyl)-1,3,5-triazine), and MP-Triazine (2-(4-methoxyphenyl)-4,6-bis(trichloromethyl)-1,3,5-triazine available from Sanwa Chemical Co., Ltd., TAZ-113 (2-[2-(3,4-dimethoxyphenyl)ethenyl]-4,6-bis(trichloroethyl)-1,3,5-triazine), and TAZ-108 (2-(3,4-dimethoxyphenyl)-4,6-bis(trichloromethyl)-1,3,5-triazine) available from Midori Chemical Co., Ltd., benzophenone, 4,4′-bisdiethylaminobenzophenone, methyl-2-benzophenone, 4-benzoyl-4′-methyldiphenylsulfide, 4-phenylbenzophenone, ethyl Michler's ketone, 2-chlorothioxantone, 2-methylthioxantone, 2-isopropylthioxantone, 4-isopropylthioxantone, 2,4-diethylthioxantone, 1-chloro-4-propoxythioxantone, ammonium salt of thioxantone, benzoin, 4,4′-dimethoxybenzoin, benzoin methyl ether, benzoin ethyl ether, benzoin isopropyl ether, benzoin isobutyl ether, benzoin dimethyl ketal, 1,1,1-trichloroacetophenone, diethoxyacetophenone, dibenzosuberone, methyl o-benzoyl benzoate, 2-benzoylnaphthalene, 4-benzoyl biphenyl, 4-benzoyl diphenyl ether, 1,4-benzoylbenzene, benzyl, 10-butyl-2-chloroacridone, [4-(methylphenylthio)phenyl]phenylmethane, 2-ethylanthraquinone, 2,2-bis(2-chlorophenyl)4,5,4′,5′-tetrakis(3,4,5-trimethoxyphenyl) 1,2′-biimidazole, 2,2-bis(o-chlorophenyl)4,5,4′,5′-tetraphenyl-1,2′-biimidazole, tris(4-dimethylaminophenyl)methane, ethyl-4-(dimethylamino) benzoate, 2-(dimethylamino)ethyl benzoate, and butoxyethyl-4-(dimethylamino) benzoate.

In addition to at least one of a photopolymerization initiator and a photoacid generator, it is possible to add a photosensitizer to the nanoimprint resist composition so as to adjust the wavelength in the UV region. Typical examples of the photosensitizer include, for example those disclosed by J. V. Crivello, Adv. in Polymer Sci, 62, 1(1984); specific examples include, for example, pyrene, pelylene, acridine orange, thioxantone, 2-chlorothioxantone, benzoflavin, N-vinylcarbazole, 9,10-dibutoxyanthracene, anthraquinone, coumarin, ketocoumarin, phenanthrene, camphorquinone, and phenothiazine derivatives.

The photosensitizer content of the nanoimprint resist composition is preferably 30% by mass or less, more preferably 20% by mass or less, and most preferably 10% by mass or less in the composition. The lower limit of the photosensitizer content is not specifically limited, however, it should be around 0.1% by mass for the resist composition to exert its effect.

The light used for initiation of polymerization include radiation rays, in addition to lights or electromagnetic waves with wavelengths in the regions of ultraviolet light, near-ultraviolet light, far-ultraviolet, visible light, infrared light, etc. Examples of radiation rays include, for example, microwaves, electron beams, EUV, and X-ray. Moreover, laser beams such as 248 nm-excimer laser, 193 nm-excimer laser, or 172-nm excimer laser can be employed. These lights may be either monochrome light (single-wavelength light) passed though an optical filter or composite light with different wavelengths. As the exposure process, multiplex exposure is possible. After patterning, it is possible to perform additional full-surface exposure in order to increase the film strength, etching resistance, and the like.

It is necessary to select an appropriate photopolymerization initiator in accordance with the wavelength of the light source to be employed. In addition, it is preferable to use a photopolymerization initiator that produces no gas during mold-pressing and exposure. Once gas is generated, the mold become soiled, and therefore, it becomes necessary to wash the mold frequently or it results poor pattern transfer accuracy due to the deformation of the photo-nanoimprint lithography curable composition injected in the mold. Photopolymerization initiators that produce no gas are preferable in terms of, for example, less likelihood of mold soiling, less mold washing frequency, and resistance to pattern transfer accuracy decrease since the photo-nanoimprint lithography curable composition is less likely to deform in the mold.

The nanoimprint resist composition contains 0.001% by mass to 5% by mass of at least one of a fluorine surfactant, a silicone surfactant, and a fluorine/silicone surfactant. The surfactant content of the composition is preferably 0.002% by mass to 4% by mass, most preferably 0.005% by mass to 3% by mass.

A surfactant content of less than 0.001% by mass results in poor uniformity upon coating, and a surfactant content of greater than 5% by mass degrades mold transfer characteristics. Such a fluorine surfactant, silicone surfactant and fluorine/silicone surfactant may be used singly or in combination. It is preferable for the resist composition to contain both a fluorine surfactant and a silicone surfactant or contain a fluorine/silicone surfactant. It is most preferable for the resist composition to contain a fluorine/silicone surfactant.

It should be noted herein that the fluorine/silicone surfactant refers to a surfactant that fulfills requirements of both of the fluorine surfactant and silicone surfactant.

The use of such a surfactant makes it possible to, for example, overcome the problems of coating defects such as striation that occurs when the nanoimprint resist composition is applied over the substrate, generation of scale-like pattern in the resist due to uneven dryness over the resist film, etc., increase the flowability of the composition so that it flows into the cavities of the mold concaves, improve the separation between the mold and resist, increase the adhesion between the resist and substrate, and lower the viscosity of the composition. In particular, adding the surfactant to the nanoimprint resist composition significantly improves coating uniformity and thus it is possible to obtain excellent coating properties regardless the substrate size upon coating in which a spin coater or slit scan coater is used.

Examples of nonionic fluorine surfactants include, for example, FLUORAD FC-430, FC-431 (available from Sumitomo 3M, Co., Ltd.); SURFLON S-382 (available fromAsahi Glass Co., Ltd.); EFTOP EF-122A, EF-122B, EF-122C, EF-121, EF-126, EF-127, MF-100 (available from Tohkem Products Corp.); PF-636, PF-6320, PF-656, PF-6520 (available from OMNOVA Solutions Inc.); FTERGENT FT250, FT251, DFX18 (available from NEOS); UNIDYNE DS-401, DS-403, DS-451 (available from Daikin Industries, Ltd.); and MEGAFAC 171, 172, 173, 178K, 178A (available from Dainippon Ink and Chemicals, Inc.). Examples of nonionic silicone surfactants include, for example, SI-10 series (available from TAKEMOTO OIL & FAT Co., Ltd.); MEGAFAC PAINTAD 31, (available from Dainippon Ink and Chemicals, Inc.), and KP-341 (available from Shin Etsu Chemical Co., Ltd.).

Examples of the fluorine/silicone surfactant include, for example, X-70-090, X-70-091, X-70-092, X-70-093 (available from Shin Etsu Chemical Co., Ltd.), and MEGAFAC R-08, XRB-4 (available from Dainippon Ink and Chemicals, Inc.).

In addition to the above surfactants, the nanoimprint resist composition may contain other nonionic surfactant(s) for the purpose of improving the flexibility and the like of the photo-nanoimprint lithography curable composition. Examples of commercially available products of such additional nonionic surfactants include, for example, PIONIN D-3110, D-3120, D-3412, D-3440, D-3510, D-3605 (polyoxyethylene alkylamines), PIONIN D-1305, D-1315, D-1405, D-1420, D-1504, D-1508, D-1518 (polyoxyethylene alkylethers), PIONIN D-2112-A, D-2112-C, D-2123-C (polyoxyethylene monofatty acid esters), PIONIN D-2405-A, D-2410-D, D-2110-D (polyoxyethylene difatty acid esters), and PIONIN D-406, D-410, D-414, D-418 (polyoxyethylene alkylphenylethers), all available from TAKEMOTO OIL & FAT Co., Ltd; and SURFYNOL 104S, 420, 440, 465, 485 (polyoxyethylene tetramethyldecindiol diether) available from Nisshin Chemical Industries. Furthermore, polymerizable unsaturated group-containing reactive surfactants may be used in combination with the above surfactants. Examples of such reactive surfactants include, for example, allyloxypolyethylene glycol monomethacrylate (BLENMER PKE series available from Nippon Oil & Fats Co., Ltd.), nonylphenoxypolyethylene glycol monomethacrylate (BLENMER PNE series available from Nippon Oil & Fats Co., Ltd.), nonylphenoxypolypropylene glycol monomethacrylate (BLENMER PNP series available from Nippon Oil & Fats Co., Ltd.), nonylphenoxypoly(ethylene glycol-propylene glycol) monomethacrylate (BLENMER PNEP-600 available from Nippon Oil & Fats Co., Ltd.), and AQUALON RN-10, RN-20, RN-30, RN-50, RN-2025, HS-05, HS-10, HS-20 available from Dai-ichi Kogyo Seiyaku Co., Ltd.

In addition to the above ingredients, it is possible to add releasing agents, silane coupling agents, polymerization inhibitors, antioxidants, UV absorbers, light stabilizers, age resistors, plasticizers, adhesion accelerators, thermal polymerization initiators, colorants, inorganic particles, elastomer particles, photoacid generators, photoacid proliferators, photobase generators, basic compounds, flow adjusters, antifoaming agents, and/or dispersants to the nanoimprint resist composition where necessary.

In order to further improve the separation of mold, it is possible to optionally add a releasing agent to the nanoimprint resist composition. More specifically, such a releasing agent is added in order for the mold pressed against a layer formed of the nanoimprint resist composition to be separated from the resin layer without causing surface disturbance or removal of the resin layer. Examples of the releasing agent include, for example, those known in the art; for example, any of silicone releasing agents, solid waxes such as polyethylene wax, amid wax and Teflon® wax, fluorine compounds and phosphate ester compounds can be used. Alternatively, these releasing agents may be attached to the mold.

Silicone releasing agents provide excellent separation particularly when combined with the photocurable resin, thereby reducing the occurrence of “plate removal” phenomenon. Silicone releasing agents are releasing agents that have an organopolysiloxane structure as basic structure, corresponding, for example, to unmodified or modified silicone oils, trimethylsiloxysilicate-containing polysiloxanes, and silicone acrylic resins.

Modified silicone oils are ones in which at least one of the side chain and terminal of the polysiloxane is modified, and are classified into reactive silicone oils and non-reactive silicone oils. Examples of reactive silicone oils include, for example, amino-modified silicone oils, epoxy-modified silicone oils, carboxyl-modified silicone oils, carbinol-modified silicone oils, methacryl-modified silicone oils, mercapto-modified silicone oils, phenol-modified silicone oils, one-terminal reactive silicone oils, and heterogeneous functional group-modified silicone oils. Examples of non-reactive silicone oils include, for example, polyether-modified silicone oils, methylstyryl-modified silicone oils, alkyl-modified silicone oils, higher fatty acid ester-modified silicone oils, hydrophilic specially-modified silicone oils, higher alkoxy-modified silicone oils, higher fatty acid-modified silicone oils, and fluorine-modified silicone oils.

Two or more of the above modifications may be introduced into one polysiloxane molecule.

It is preferable that the silicone oils have moderate compatibility with the composition ingredients. In particular, when a reactive silicone oil is used that is reactive with additional coating components to be added in the composition as needed, the reactive silicone oil is fixed by chemical bonding in the cured film obtained by curing of the nanoimprint resist composition, and therefore, adhesion decrease, soiling, degradation, etc., of the cured film are less likely to occur. The use of such a reactive silicone oil is particularly effective in increasing adhesion to the vapor-deposited film during the vapor deposition step. In the case of silicones modified with photocurable functional groups, such as (meth)acryloyl-modified silicone or vinyl-modified silicone, they crosslink with the nanoimprint resist composition and thereby provide excellent post-curing characteristics.

Trimethylsiloxysilicate-containing polysiloxanes are preferable since they easily bleed out to the coating surface to provide excellent separation, offer excellent adhesion even when bled out to the surface, and provide excellent adhesion to the metal vapor-deposition layer and overcoat layer. The above releasing agents may be added to the nanoimprint resist composition singly or in combination.

When the releasing agent is added to the nanoimprint resist composition, it is preferably added in a proportion of 0.001% by mass to 10% of the composition, and more preferably 0.01% by mass to 5% by mass. When the releasing agent content is less than 0.001% by mass, it may result in poor effects of improving the separation between the mold and the photo-nanoimprint lithography curable composition. When the releasing agent content is greater than 10% by mass, it may result in such problems as disturbed coating surface due to cissing that occurs upon application of the composition, reduction in adhesion of the substrate itself and nearby layers (e.g., vapor-deposited layer) in the product, and film destroy upon transfer due to too weak film strength. On the other hand, when the releasing content is 0.01% by mass or greater, it results in sufficient effects of increasing the separation between the mold and photo-nanoimprint lithography curable composition. When the releasing agent content is 10% by mass or less, it can avoid such problems as disturbed coating surface due to cissing that occurs upon application of the composition, reduction in adhesion of the substrate itself and nearby layers (e.g., vapor-deposited layer) in the product, and film destroy upon transfer due to too weak film strength.

The nanoimprint resist composition may contain a polymerization inhibitor for the purpose of increasing the storage stability and the like. Examples of such a polymerization inhibitor include, for example, phenols such as hydroquinones, tert-butyl hydroquinone, catechol and hydroquinone monoethyl ether; quinones such as benzoquinone and diphenyl benzoquinone; phenothiazines; and coppers. The polymerization inhibitor is preferably added in the photo-nanoimprint lithography curable composition in a proportion of 0.001% by mass to 10% by mass of the composition.

Examples of commercially available products of the antioxidants include, for example, IRGANOX 1010, 1035, 1076, 1222 (available from Ciba-Geigy); ANTIGENE P, 3C, FR, SUMILIZER S, SUMILIZER GA-80 (available from Sumitomo Chemical Company, Ltd.); and ADK STAB A080, A0503 (available from ADEKA Corporation). These antioxidants may be used singly or in combination, and can be used as an admixture as well. It is preferable that the antioxidant be added in a proportion of 0.01% by mass to 10% by mass of the composition. Examples of commercially available products of the UV absorbers include, for example, TINUVIN P, 234, 320, 326, 327, 328, 213 (available from Ciba-Geigy); and SUMISORB 110, 130, 140, 220, 250, 300, 320, 340, 350, 400 (available from Sumitomo Chemical Company, Ltd.). It is preferable that the UV absorber be added optionally to the photo-nanoimprint lithography curable composition in a proportion of 0.01% by mass to 10% by mass of the composition.

Examples of commercially available products of the light stabilizers include, for example, TINUVIN 292, 144, 622LD (available from Ciba-Geigy); and SANOL LS-770, 765, 292, 2626, 1114, 744 (available from Sankyo Kasei Co., Ltd.). It is preferable that the light stabilizer be added to the photo-nanoimprint lithography curable composition in a proportion of 0.01% by mass to 10% by mass of the composition.

Examples of commercially available products of the age resistors include, for example, ANTIGENE W, S, P, 3C, 6C, RD-G, FR, AW (Sumitomo Chemical Company, Ltd.). It is preferable that the age resistor be added in an amount of 0.01% by mass to 10% by mass of the composition.

It is also possible to add a plasticizer to the nanoimprint resist composition for the purpose of adjusting adhesion to the substrate, film flexibility, film hardness, etc. Preferred examples of the plasticizers include, for example, dioctyl phthalate, didodecyl phthalate, triethylene glycol dicaprilate, dimethyl glycol phthalate, tricresyl phosphate, dioctyl adipate, dibutyl sebacate, triacetyl glycerin, dimethyl adipate, diethyl adipate, di(n-butyl) adipate, dimethyl suberate, diethyl suberate, and di(n-butyl) suberate. The plasticizer can be optionally added in a proportion of 30% by mass or less of the composition, preferably 20% by mass or less, and more preferably 10% by mass or less. The plasticizer content is preferably 0.1% by mass or greater in order for it to exert its effect.

The nanoimprint resist composition may contain an adhesion accelerator for the purpose of adjusting adhesion to the substrate, for example. Examples of the adhesion accelerator include, for example, benzimidazoles, polybenzimidazoles, lower hydroxyalkyl-substituted pyridine derivatives, nitrogen-containing heterocyclic compounds, urea or thiourea, organophosphorus compounds, 8-oxyquinoline, 4-hydroxypteridine, 1,10-phenanthroline, 2,2′-bipyridine derivatives, benzotriazoles, phenylenediamine compounds, 2-amino-1-phenylethanol, N-phenylethanolamine, N-ethyldiethanolamine, N-ethylethanolamine and derivatives thereof, and benzothiazoles. The adhesion accelerator is preferably added in a proportion of 20% by mass or less of the composition, more preferably 10% by mass or less, and most preferably 5% by mass or less. The adhesion accelerator content is preferably 0.1% by mass or greater in order for it to exert its effect.

When the nanoimprint resist composition is to be cured, it is possible to add a thermal polymerization initiator as needed. Preferred examples of the thermal polymerization initiator include, for example, peroxides and azo compounds. Specific examples thereof include, for example, benzoyl peroxide, tert-butyl-peroxy benzoate, and azobisisobutylonitrile.

The nanoimprint resist composition may contain a photobase generator where necessary for the purpose of adjusting the pattern shape, sensitivity and the like. Preferred examples of the photobase generator include, for example, 2-nitrobenzylcyclohexyl carbamate, triphenyl methanol, o-carbamoyl hydroxylamide, o-carbomoyl oxime, [[(2,6-dinitrobenzyl)oxy]carbonyl]cyclohexylamine, bis[[(2-nitrobenzyl)oxy]carbonyl]hexane-1,6-diamine, 4-(methylthiobenzoyl)-1-methyl-1-morpholinoethane, (4-morpholinobenzoyl)-1-benzyl-1-dimethylaminopropane, N-(2-nitrobenzyloxycarbonyl) pyrrolidine, hexamine cobalt (III) tris-(triphenylmethyl borate), 2-benzyl-2-dimethylamino-1-(4-morpholinophenyl)-butanone, 2,6-dimethyl-3,5-diacetyl-4-(2′-nitrophenyl)-1,4-dihydropyridine, and 2,6-dimethyl-3,5-diacetyl-4-(2,4′-dinitrophenyl)-1,4-dihydropyridine.

As an optional ingredient the nanoimprint resist composition may contain a filler for the purpose of improving the heat resistance, mechanical strength, tackiness and the like of the coating. Fine inorganic particles of ultrafine particle size are employed. As used herein “ultrafine particles” refers to particles of the order of submicrons in size, and mean particles that are smaller in size than so-called “fine particles” that have a particle size ranging from several micrometers to several hundreds of micrometers. The specific size of the fine inorganic particles differs depending on the intended purpose and grade of the optical article to which the photo-nanoimprint lithography curable composition is applied; however, in general, fine inorganic particles that have a primary particle size of 1 nm to 300 nm are preferable. A primary particle size of less than 1 nm makes it difficult to sufficiently improve the shape/dimension retaining ability and separation ability of the photo-nanoimprint lithography curable composition. A primary particle size of greater than 300 nm impairs transparency of resin and may results in insufficient transparency depending on the intended purpose of the optical article. When the primary particle size is 1 nm or greater, it is possible to sufficiently improve the shape/dimension retaining ability and separation ability of the photo-nanoimprint lithography curable composition. When the primary particle size is 300 nm or less, it is preferable in terms of transparency since transparency necessary for resin curing can be ensured.

Specific examples of fine inorganic particles include, for example, fine particles of metal oxides such as SiO₂, TiO₂, ZrO₂, SnO₂ and Al₂O₃. Among them, fine inorganic particles that can be dispersed in colloidal form and that have a particle size of the order of submicrons are preferable. In particular, colloidal silica (SiO₂) fine particles are preferable.

It is preferable that the fine inorganic particles be added in the photo-nanoimprint lithography curable composition in a proportion of 1% by mass to 70% by mass based on the total amount of solids of the composition, and most preferably in a proportion of 1% by mass to 50% by mass. By setting the fine inorganic particle content to 1% by mass or greater, it is possible to sufficiently increase the shape/dimension retaining ability and separation ability of the photo-nanoimprint lithography curable composition. When the fine inorganic particle content is made greater than 70%, the composition becomes so fragile that sufficient strength and surface hardness may not be obtained after cured by exposure. By setting the fine inorganic particle content to 1% or greater, it is possible to sufficiently increase the shape/dimension retaining ability and separation ability of the photo-nanoimprint lithography curable composition. Setting the fine inorganic particle content to 70% or less is preferable in terms of strength and surface hardness after cured by exposure.

The nanoimprint resist composition may further contain as an optional ingredient elastomer particles for the purpose of increasing the mechanical strength, flexibility and the like.

The elastomer particles that can be added to the nanoimprint resist composition as an optional ingredient preferably have an average particle size of 10 nm to 700 nm, and more preferably 30 nm to 300 nm. Examples thereof include, for example, particles of elastomers such as polybutadiene, polyisoprene, butadiene/acrylonitrile copolymers, styrene/butadiene copolymers, styrene/isoprene copolymers, ethylene/propylene copolymers, ethylene/α-olefin copolymers, ethylene/α-olefin/polyene copolymers, acryl rubbers, butadiene/(meth)acrylate copolymers, styrene/butadiene block copolymers, and styrene/isoprene block copolymers. Moreover, core/shell particles obtained by coating the above elastomer particles with methyl methacrylate polymer, methyl methacrylate/glycidyl methacrylate copolymer or the like can be employed. The elastomer particles may have a crosslinked structure.

Examples of commercially available products of elastomer particles include, for example, RESINOUS BOND RKB (available from Resinous Kasei Co., Ltd.) and TECNO MBS-61, MBS-69 (available from Techno Polymer Co., Ltd.).

These types of elastomer particles may be used singly or in combination. The elastomer particle content of the nanoimprint resist composition is preferably 1% by mass to 35% by mass, more preferably 2% by mass to 30% by mass, and most preferably 3% by mass to 20% by mass.

The nanoimprint resist composition may contain a known antioxidant, which prevents color degradation due to exposure to light or acidic gas such as ozone, active oxygen, NOₓ and SOₓ (where x is an integer). Examples of such an antioxidant include, for example, hydrazides, hindered amine antioxidants, nitrogen-containing heterocyclic mercapto compounds, thioether antioxidants, hindered phenol antioxidants, ascorbic acids, zinc sulfate, thiocyanates, thiourea derivatives, sugars, nitrites, subsulfates, thiosulfates, and hydroxylamine derivatives.

The nanoimprint resist composition may optionally contain a basic compound for the purpose of preventing cure shrinkage and increasing thermal stability. Examples of such a basic compound include, for example, amines, nitrogen-containing heterocyclic compounds such as quinolines and quinolizines, basic alkali metal compounds and basic alkaline earth metal compounds. Among them, amines are preferable in view of their compatibility with photopolymerizable monomers. Examples of amines include, for example, octylamine, naphthylamine, xylenediamine, dibenzylamine, diphenylamine, dibutylamine, dioctylamine, dimethylaniline, quinuclidine, tributylamine, trioctylamine, tetramethylethylenediamine, tetramethyl-1,6-hexamethylenediamine, hexamethylenetetraamine, and triethanolamine.

The nanoimprint resist composition may optionally contain a photoacid generator that initiates photopolymerization by irradiation with energy ray such as ultraviolet ray for the purpose of accelerating the photo-curing reaction. Preferred examples of the photoacid generator include, for example, onium salts such as arylsulfonium salts and aryliodonium salts.

Examples of onium salts include, for example, diphenyliodonium, 4-methoxydiphenyliodonium, bis(4-methylphenyl)iodonium, bis(4-tert-butylphenyl)iodonium, bis(dodecylphenyl)iodonium, triphenylsulfonium, diphenyl-4-thiophenoxyphenylsulfonium, bis[4-(dip henylsulfonio)-phenyl]sulfide, bis[4-(di(4-(2-hydroxyethyl)phenyl)sulfonio)-phenyl]sulfide, and 1,5-2,4-(cyclopentadienyl)[1,2,3,4,5,6-111-(methylethyl)-benzene]-Fe(1+). In addition, onium salts that have anions can also be used. Specific examples of anions include, for example, tetrafluoroborate (BF₄⁻), hexafluorophosphate (PF₆⁻), hexafluoroantimonate (SbF₆⁻), hexafluoroacenate (AsF₆⁻), hexachloroantimonate (SbCl₆⁻), perchlorate ion (CIO₄⁻), trifluoromethanesulfonic acid ion (CF₃SO₃⁻), fluorosulfonic acid ion (FSO₃⁻), toluenesulfonic acid ion, trinitrobenzenesulfonic acid anion, and trinitrotoluenesulfonic acid anion.

Among these onium salts, aromatic onium salts serve as especially effective photoacid generator. Examples of such aromatic onium salts include, for example, aromatic halonium salts disclosed by JP-A Nos. 50-151996, 50-158680, etc., Group VIA aromatic onium salts disclosed by JP-A Nos. 50-151997, 52-30899, 56-55420, 55-125105, etc., Group VA aromatic onium salts disclosed by JP-A No. 50-158698, etc., oxosulfoxonium salts disclosed by JP-A Nos. 56-8428, 56-149402, 57-192429, etc.; aromatic diazonium salts disclosed by JP-A No. 49-17040, etc., thiopyrylium salts disclosed by U.S. Pat. No. 4,139,655, ironlallene complexes, aluminum complex/photodegradable silicon compound initiators, haloids that produce hydrogen halide by exposure to light, o-nitrobenzyl ester compounds, imidosulfonate compounds, bissulfonyldiazomethane compounds, and oximesulfonate compounds.

As the above photoacid generators, for example, compounds that are used for chemically amplified photoresists and photocationic polymerization can be widely employed (see “Organic Materials for Imaging”, The Japanese Research Association for Organic Electronics Materials, Bunshin Publishing Co., Tokyo, Japan, (1993), pp. 187-192). These compounds are readily synthesized by a known method as are photoacid generators disclosed by “THE CHEMICAL SOCIETY OF JAPAN Vol.71, No.11, 1998,” and “Organic Materials for Imaging”, The Japanese Research Association for Organic Electronics Materials, Bunshin Publishing Co., Tokyo, Japan, (1993)).

Examples of commercially available products of the photoacid generators include, for example, UVI-6950, UVI-6970, UVI-6974, UVI-6990, UVI-6992 (available from Union Carbide Corp.); ADEKAOPTOMER SP-150, SP-151, SP-170, SP-171, SP-172 (available from Asahi Denka Kogyo K.K.); IRGACURE 261, IRGACURE OXEO, IRGACURE CGI-1397, CGI-1325, CGI-1380, CGI-1311, CGI-263, CGI-268, CGI-1397, CGI-1325, CGI-1380, CGI-1311 (available from Ciba Specialty Chemicals Inc.); CI-2481, CI-2624, CI-2639, CI-2064 (available from NIPPON SODA CO., LTD.); CD-1010, CD-1011, CD-1012 (available from Sartomer Company Inc.); DTS-102, DTS-103, NAT-103, NDS-103, TPS-103, MDS-103, MPI-103, BBI-103 (available from Midori Kagaku Co., Ltd.); PCI-061T, PCI-062T, PCI-020T, PCI-022T (available from NIPPON KAYAKU CO., LTD.); PHOTOINITIATOR 2074 (available from Rhodia); and UR-1104, UR-1105, UR-1106, UR-1107, UR-1113, UR-1114, UR-1115, UR-1118, UR-1200, UR-1201, UR-1202, UR-1203, UR-1204, UR-1205, UR-1207, UR-1401, UR-1402, UR-1403, UR-M1010, UR-Mi011, UR-M10112, UR-SAIT01, UR-SAIT02, UR-SAIT03, UR-SAIT04, UR-SAIT05, UR-SAIT06, UR-SAIT07, UR-SAIT08, UR-SAIT09, UR-SAIT10, UR-SAIT11, UR-SAIT12, UR-SAIT13, UR-SAIT14, UR-SAIT15, UR-SAIT16, UR-SAIT22, UR-SAIT30 (available from URAY). Among them, UVI-6970, UVI-6974, ADEKAOPTOMER SP-170, SP-171, SP-172, CD-1012 and MPI-103 can impart high photocuring sensitivity to compositions in which they are contained. The above photoacid generators can be used singly or in combination.

Moreover, it is possible to increase the curing rate by combining a polymerization initiator, which generates acid by action of energy rays, with a substance that autocatalytically generates acid by action of the generated acid. This substance is hereinafter referred to as “acid proliferator.” Examples of the acid proliferator include, for example, compounds disclosed by JP-A Nos. 08-248561 and 10-1508 and JP-B No. 3102640, more specifically, 1,4-bis(p-toluenesulfonyloxy)cyclohexane, cis-3-(p-toluenesulfonyloxy)-2-pinanol, and cis-3-(p-octanesulfonyloxy)-2-pinanol. Examples of commercially available compounds thereof include, for example, ACPRESS 11M available from Nippon Chemics Co., Ltd.

It is also possible to add a chain transfer agent to the nanoimprint resist composition for the purpose of increasing the photocuring ability. Specific examples of such a chain transfer agent include, for example, 4-bis(3-mercaptobutyryloxy)butane, 1,3,5-tris(3-mercaptobutyloxyethyl)1,3,5-triazine-2,4,6(1H, 3H, 5H)-trione, and pentaerythritoltetrakis(3-mercaptobutyrate).

Where necessary, a charge preventing agent may be added to the nanoimprint resist composition.

The charge preventing agent may be any of anionic, cationic, nonionic and amphoteric charge preventing agents. Specific examples thereof include, for example, alkyl phosphate-based anionic surfactants such as ELECTROSTRIPPER A (available from Kao Corporation) and ELENON No. 19 (available from Dai-ichi Kogyo Seiyaku Co., Ltd.), betaine-based amphoteric surfactants such as AMOGEN K (available from Dai-ichi Kogyo Seiyaku Co., Ltd.), polyoxyethylene fatty acid ester-based nonionic surfactants such as NISSAN NONION L (available from Nippon Oils & Fats Co., Ltd.), polyoxyethylene alkyl ether-based nonionic surfactants such as EMULGEN 106, 120, 147, 420, 220, 905, 910 (available from Kao Corporation) and NISSAN NONION E (available from Nippon Oils & Fats Co., Ltd.), and other nonionic surfactants such as polyoxyethylene alkylphenyl ether-based nonionic surfactants, polyalcohol fatty acid ester-based nonionic surfactants, polyoxyethylene sorbitan fatty acid ester-based nonionic surfactants, and polyoxyethylene alkylamine-based nonionic surfactants. These charge preventing agents can be used singly or in combination.

### (Resist Composition)

The resist composition of the present invention is a nanoimprint resist composition that contains the interface binder of the present invention and, where necessary, further contains additional compound(s) appropriately selected. Specifically, the interface binder of the present invention is added to the nanoimprint resist composition of the present invention for use.

It is only necessary for the interface binder to be added in the resist composition in an amount that sufficiently increase the adhesion between the resist layer and laminate for forming magnetic recording medium; it is preferably added in an amount of 0.01% by mass to 10% by mass, more preferably 0.05% by mass to 5% by mass, and most preferably 0.1% by mass to 3% by mass. An interface binder content of less than 0.01% by mass results in poor binding ability of the interface binder, and an interface binder content of greater than 10% by mass decreases the formability and coating solution stability of the resist composition.

### <Additional Compound>

The additional compound is not specifically limited and can be appropriately selected according to the intended purpose.

### (Laminate for Forming Magnetic Recording Medium)

As shown in FIG. 1A, the laminate of the present invention for forming magnetic recording medium includes, in order, a substrate 11, a magnetic layer 12, and a layer composed of the interface binder of the present invention (not shown) and, where necessary, further includes additional member(s) or layer(s) appropriately selected.

### —Substrate—

The shape, structure, size, constituent material, etc., of the substrate 11 are not specifically limited and can be appropriately determined according to the intended purpose. For example, the substrate 11 has a disc shape when the magnetic recording medium is a magnetic disc like a hard disc. The substrate 11 may have either single-layer structure or multilayer structure. Regarding the constituent material, it is possible to select from those known as substrate materials for magnetic recording media. For example, it is possible to employ aluminum, glass, silicon, quarts, and SiO₂/Si obtained by forming a thermal oxide film on silicon surface. The substrate materials can be used singly or in combination.

### —Magnetic Layer—

The material of the magnetic layer 12 is not specifically limited and can be appropriately selected from known materials according to the intended purpose; preferred examples thereof include, for example, Fe, Co, Ni, FeCo, FeNi, CoNi, CoNiP, FePt, CoPt, and NiPt. These materials can be used singly or in combination.

The thickness of the magnetic layer 12 is not specifically limited and can be appropriately set according to the intended purpose; however, it is generally 5 nm to 30nm or so.

The method of formation of the magnetic layer 12 is not specifically limited and any known method can be employed; for example, sputtering or electrodeposition can be employed for the formation of the magnetic layer 12.

Where necessary, it is also possible to form a crystal orientation layer for orientation of magnetic of the magnetic layer 12 and/or a soft magnetic undercoat layer between the substrate 11 and magnetic layer 12. In particular, the soft magnetic undercoat layer may be formed as a single layer or multilayer.

### —Layer Composed of Interface Binder—

The layer composed of the interface binder is not specifically limited as long as it is formed by surface treatment of the laminate 10 for forming magnetic recording medium with the interface binder of the present invention, and can be appropriately selected according to the intended purpose.

The layer composed of the interface binder of the present invention may be directly formed on a surface-side of the magnetic layer 12 or may be formed on a single layer or multiple layers of additional member or layer to be described later provided on the magnetic layer 12.

### —Additional Member (Layer)

The additional member or layer is not specifically limited and can be appropriately selected according to the intended purpose; for example, a surface layer 13 and the like can be exemplified.

Only one of these additional layers may be provided. Alternatively, two or more of the additional layers may be provided. In addition, the additional layer may have a single-layer structure or laminate structure.

The material of the additional layers is not specifically limited and can be appropriately selected from known materials according to the intended purpose.

The shape, structure, size, constituent material, etc., of the surface layer 13 are not specifically limited and can be appropriately determined according to the intended purpose. Regarding the constituent material, carbon, Ti, TiN, Ni, and Ta can be exemplified, for example.

### (Manufacturing Method of Magnetic Recording Medium)

The manufacturing method of magnetic recording medium of the present invention includes at least a surface treatment step, preferably includes a resist layer forming step, an activation step, an ablation step, etc., and where necessary, further includes additional step(s) appropriately selected.

### <Surface Treatment Step>

The surface treatment step is a step of surface-treating a surface of a laminate for forming magnetic recording medium by use of the interface binder of the present invention.

By the surface treatment step, a layer composed of the interface binder of the present invention is formed over the surface of the laminate.

The method of surface treatment by use of the interface binder is not specifically limited and can be appropriately selected from known methods according to the intended purpose. For example, the surface treatment method can be selected from a method in which an interface binder layer is deposited by bar coating, dip coating, spin coating, vapor deposition or the like, and a method in which an interface binder layer is formed on a substrate surface by normal temperature annealing by immersion. At this point, the interface binder may be used as it is or diluted with solvent or the like prior to use.

After the interface binder layer has been formed on the laminate surface by any of the above-described methods, as a post-formation treatment, it is preferable to carry out, for example, high-temperature annealing at about 100° C. to facilitate bonding reactions between the interface binder and laminate for the formation of interface bonds. Furthermore, it is preferable that excess interface binder be removed by washing with solvent or the like. Washing of the laminate surface may precede high-temperature annealing or vice versa. However, it is preferable to perform washing prior to annealing since excess interface binder can be effectively removed.

It should be noted that the surface treatment step and a later-described resist layer forming step may be combined into a single step by adding the interface binder to a resist solution. When the interface binder is added to the resist solution, it is preferably added in an amount of 1% by mass to 10% by mass based on the amount of solids in the resist solution, because the interface binding ability with respect to the laminate decreases. Moreover, it is preferably added in an amount of 1% by mass to 5% by mass in view of the ablation ability in the later-described ablation step.

### <Resist Layer Forming Step>

The resist layer forming step is a step of forming a resist layer over the laminate for forming magnetic recording medium whose surface has been treated in the surface treatment step.

The resist layer is formed by application of the nanoimprint resist composition by means of a generally well-known coating method such as dip coating, air knife coating, curtain coating, wire bar coating, gravure coating, extrusion coating, spin coating, or slit scanning. The thickness of the resist layer composed of the nanoimprint resist composition differs depending on the intended use purpose; however, it is 0.05 μm to 30 μm. The nanoimprint resist composition may be applied multiple times.

The substrate or support onto which the nanoimprint resist composition is applied is not specifically limited; examples include, for example, quarts, glass, optical films, ceramic materials, vapor-deposited films, magnetic films, reflective films, metal substrates made of Ni, Cu, Cr, Fe or the like, paper, SOG, polymer substrates such as polyester films, polycarbonate films and polyimide films, TFT array substrates, PDP electrode plates, glass substrates, transparent plastic substrates, conductive base materials such ITO and metal, insulating base materials, and semiconductor substrates made of silicone, silicone nitride, polysilicone, silicone oxide, amorphous silicone or the like. The substrate may have a plate shape or roll shape.

The light source used for curing of the nanoimprint resist composition is not specifically limited; examples thereof include, for example, high-energy ionizing radiation, and lights and radiation rays with wavelengths in the regions of ultraviolet light, near-ultraviolet light, far-ultraviolet, visible light, infrared light, etc. As a high-energy ionizing radiation source, electron beams accelerated by an accelerator such as Cockeroft-Walton Accelerator, van de Graaff Accelerator, linear accelerator, betatron, or cyclotron can be employed most conveniently and economically for industrial reasons. Additionally, radiation rays emitted from radioisotopes, atomic reactors and the like can be employed, such as γ-ray, X-ray, α-ray, neutron beams and proton beams. Examples of the UV light source include, for example, a ultraviolet fluorescent lamp, low-pressure mercury lamp, high-pressure mercury lamp, ultrahigh-pressure mercury lamp, xenon lamp, carbon arc lamp, and sun lamp. Radiation rays include, for example, microwaves and EUV. Furthermore, laser beams used in fine patterning of semiconductor devices, such as LEDs, semiconductor lasers, 248 nm-KrF excimer laser and 193 nm-ArF excimer laser can be suitably employed. These lights may be either monochrome light or mixed light with different wavelengths.

### <Activation Step>

The activation step is a step of activating a surface of the laminate for forming magnetic recording medium by any of UV irradiation, oxygen plasma treatment, oxygen ashing treatment, alkali treatment and acid treatment, so that the mole ratio of OH group-containing elements becomes 20% or more over the laminate surface.

By cleaning and activating a surface of the laminate 10 for forming magnetic recording medium by any of UV irradiation, oxygen plasma treatment, oxygen ashing treatment, alkali treatment and acid treatment prior to treatment with the interface binder (i.e., the above surface treatment step), it is possible to increase the number of bonds formed in the interface between the resist layer and laminate, so that the interface becomes harder and the treated surface becomes clean.

### <Ablation Step>

The ablation step is a step of ablating a single or multiple layers that contain at least the interface binder and that have been formed in the surface treatment step, by any of oxygen plasma treatment, oxygen ashing treatment, and UV ozone treatment.

### <Additional Step>

The additional step is not specifically limited and can be appropriately selected according to the intended purpose; examples thereof include, for example, a pattern forming step, curing step, etching step, resist layer removing step, non-magnetic layer embedding step, rinse step, and water washing step. Steps other than these exemplified steps, i.e., pattern forming step, curing step, etching step, resist layer removing step, non-magnetic layer embedding step, rinse step, and water washing step are not specifically limited and can be appropriately selected from steps of known pattern formation processes. These additional steps can be employed singly or in combination.

### —Pattern Forming Step—

The pattern forming step is a step of forming a pattern (particularly a fine convexo-concave pattern) on a resist layer composed of the nanoimprint resist composition. Specifically, the nanoimprint resist composition is applied and, where necessary, dried to form a resist layer (pattern forming layer) composed of the nanoimprint resist composition, thereby forming a pattern receiver. A mold is then pressed against a pattern forming surface of the pattern receiver to transfer the mold pattern, and the pattern forming layer provided with the fine convexo-concave pattern is exposed for curing. Photoimprint lithography used in the pattern formation method is capable of lamination and multiplex patterning and can be used in combination with normal thermal imprint lithography.

Mold materials that can be used in photo-nanoimprint lithography will be described below. In photo-nanoimprint lithography using the photo-nanoimprint lithography resist composition, at least one of the mold and substrate needs to be made of optically transparent material. In photo-nanoimprint lithography, a photo-nanoimprint lithography curable composition is applied on a substrate, an optically transparent mold is pressed against the composition, and the composition is cured by exposure to light applied from the mold side. Alternatively, a photo-nanoimprint lithography curable composition is applied on an optically transparent substrate, a mold is pressed against the composition, and the composition is cured by exposure to light applied from the substrate side.

Light irradiation may be carried out with the mold being pressed against the composition or may be carried out after the mold has been separated away. However, light irradiation is preferably carried out with the mold pressed against the composition.

As the above mold, a mold having a pattern to be transferred is used. It is possible to form a pattern of desired size on a mold by, for example, photolithography or electron beam imaging. However, the method of mold pattern formation is not specifically limited.

Optically transparent mold materials are not specifically as long as they have a predetermined strength and durability; specific examples thereof include, for example, glass, quarts, optically transparent resins such as PMMA and polycarbonate resins, vapor-deposited transparent metal films, flexible films such as those made of polydimethylsiloxane, photocurable films, and metal films.

Meanwhile, non-optically transparent mold materials are not specifically limited as long as they have a predetermined strength; specific examples thereof include, for example, ceramic materials, vapor-deposited films, magnetic films, reflective films. metal substrates such as those made of Ni, Cu, Cr, Fe or the like, and substrates made of SiC, silicone nitride, polysilicone, silicone oxide, amorphous silicone or the like. The mold may be either a plate-shape mold or roll-shaped mold. A roll-shaped mold is employed particularly where continuous pattern transfer is needed.

The above mold is preferably subjected to releasing treatment so that separation between the photo-nanoimprint lithography curable composition and mold improves. Silicone silane coupling agents and fluorine silane coupling agents may be used. In addition, for example, commercially available releasing agents such as OPTOOL DSX (available from Daikin Industries, Ltd.) and NOVEC EGC-1720 (available from Sumitomo 3M, Co., Ltd.) can be suitably used.

In general, photoimprint lithography is preferably carried out with the mold pressure being 10 atmospheric pressure or less. By so doing advantages are provided. Namely, the mold and substrate are less likely to deform and thereby pattern transfer accuracy increase, and moreover, it becomes possible to use a small device since the pressure to be applied is small. It is preferable to select a mold pressure range within which mold pattern transfer uniformity can be ensured while reducing residual pieces of film at convex portions of the mold, which film is formed of the photo-nanoimprint lithography curable composition.

It is only necessary for the light irradiation dose in photoimprint lithography to be sufficiently higher than the level required for curing. The irradiation dose required for curing is determined depending on the consumption level of unsaturated bonds in the photo-nanoimprint lithography curable composition and on the tackiness of the cured film.

In photoimprint lithography, light irradiation is carried out with the temperature of the substrate being kept at room temperature. However, light irradiation may be carried out while heating the substrate to provide increased reactivity. Light irradiation may be carried out in vacuo because by so doing it is possible to prevent entry of air bubbles and reduction in reactivity due to entry of oxygen, and to increase adhesion between the mold and photo-nanoimprint lithography curable composition. A preferred range of degree of vacuum is 10⁻¹ Pa to normal pressure.

The nanoimprint resist composition can be prepared as a solution by, after mixing the above ingredients together, filtrating through for example a 0.05-5.0 μm pore size filter. Mixing and dissolution of the photo-nanoimprint lithography curable composition is generally carried out at a temperature from 0° C. to 100° C. Filtration may be carried out in multiple stages or may be repeated multiple times.

In addition, the flow-through may be recovered for re-filtration. The material of the filter is not specifically limited, and those made of polyethylene resin, polypropylene resin, fluorine resin, nylon resin, etc., can be employed.

### —Curing Step—

The curing step is a step of curing the formed pattern. The curing step is not specifically limited and can be appropriately selected from known curing processes according to the intended purpose; for example, full-surface heating treatment or full-surface exposure treatment can be cited as suitable treatment.

The method of full-surface heating treatment is, for example, a method of heating the formed pattern. Full-surface heat treatment increases the strength of the pattern surface. The heating temperature in the full-surface heat treatment is preferably 80° C. to 200° C., more preferably 90° C. to 180° C. By setting the heating temperature to 80° C or higher, the film strength tends to increase by heat treatment.

By setting the heating temperature to 200° C. or less, decomposition of the ingredients of the photo-nanoimprint lithography curable composition occurs, making it is possible to more effectively prevent the film from being weak and fragile. The device for full-surface heat treatment is not specifically limited and can be appropriately selected from known devices according to the intended purpose; examples thereof include, for example, a dry oven, hot plate, and IR heater. When a hot plate is used, heat treatment is preferably carried out in such a way that the substrate having formed pattern is heated above the hot plate in order to ensure uniform heating.

The full-surface exposure treatment is, for example, a method of exposing the entire surface of the formed pattern. Full-surface exposure facilitates curing inside the composition that constitutes the resist layer (photosensitive layer) and thereby the pattern surface hardens. In this way, the etching resistance can be increased. The device for full-surface exposure treatment is not specifically limited and can be appropriately selected from known devices according to the intended purpose; for example, a UV exposure device such as a high-pressure mercury lamp can be cited as a suitable example.

### —Etching Step—

The etching step is a step of removing base portions that are not covered with the resist pattern. The etching step can be carried out using a process appropriately selected from known etching processes. With the etching step, a pattern of thin film can be obtained.

The etching treatment employs either wet etching (treatment that involves use of etching solution) or dry etching (treatment that involves use of reactive gas activated by plasma discharge under reduced pressure).

The etching treatment may be carried out batchwise by etching a set of substrates at a time, or may be carried out for each substrate.

Many etching solutions for use in wet etching have been developed and used, with typical examples including, for example, ferric chloride/hydrochloric acid-based etching solutions, hydrochloric acid/nitric acid-based etching solutions, and hydrobromic acid-based etching solutions. For etching of Cr, cerium nitrate ammonium solution, mixture of cerium nitrate and hydrogen peroxide solution, etc., are employed. For etching of Ti, diluted hydrofluoric acid, mixture solution of hydrofluoric acid and nitric acid, etc., are employed. For etching of Ta, mixture solution of ammonium solution and hydrogen peroxide solution, etc., are employed. For etching of Mo, hydrogen peroxide solution, mixture of ammonia water and hydrogen peroxide solution, mixture of phosphoric acid and nitric acid, etc., are employed. For etching of MoW and Al, mixture solution of phosphoric acid and nitric acid, mixture solution of hydrofluoric acid and nitric acid, mixture solution of phosphoric acid, nitric acid and acetic acid, etc., are employed. For etching of ITO, diluted royal water, ferric chloride solution, hydrogen iodide water, etc., are employed. For etching of SiNₓ and SiO₂, buffered hydrofluoric acid, mixture solution of hydrofluoric acid and fluorinated ammonium, etc., are employed. For etching of Si and poly Si, mixture of hydrofluoric acid, nitric acid and acetic acid, etc., are employed. For etching of W, mixture solution of ammonia water and hydrogen peroxide solution, etc., are employed. For etching of PSG, mixture solution of nitric acid and hydrofluoric acid, etc., are employed. For etching of BSG, mixture solution of hydrofluoric acid and fluorinated ammonium, etc., are employed.

Wet etching may employ either shower mode or dipping mode. However, since etching rate, in-plane etching uniformity, and line width precision are greatly dependent on the etching temperature, the etching conditions need to be optimized according to the type of substrate, intended application, and line width. In addition, in the case of wet etching, it is desirable to carry out post-bake treatment in order to avoid under cut that occurs due to permeation of etching solution. In general, post-bake treatment is carried out at, but not necessarily limited to, a temperature ranging from 90° C. to 140° C. or so.

Dry etching generally employs a parallel-plate dry etching apparatus in which a pair of parallel electrodes is placed in a vacuum device and a substrate is placed onto one of the electrodes. The mode of dry etching is classified into two types: reactive ion etching (RIE) mode where ions play a key role, and plasma etching (PE) mode where radicals play a key role, depending on which electrode a plasma-generating high frequency power source is connected to (i.e., whether the power source is connected to the electrode onto which the substrate or the opposite electrode).

Etchant gases for use in dry etching are so selected that they match respective target film types. More specifically, for etching of a-Si/n⁺ and s-Si, carbon tetrafluoride (chlorine)+oxygen, carbon tetrafluoride (sulfur hexafluoride)+hydrogen chloride (chlorine), etc., are employed. For etching of a-SiNₓ, carbon tetrafluoride+oxygen, etc., are employed. For etching of a-SiOₓ, carbon tetrafluoride+oxygen, carbon trifluoride+oxygen, etc., are employed. For etching of Ta, carbon tetrafluoride (sulfur hexafluoride)+oxygen, etc., are employed. For etching of MoTa/MoW, carbon tetrafluoride+oxygen, etc., are employed. For etching of Cr, chlorine+oxygen, etc., are employed. For etching of Al, boron tetrachloride+chlorine, hydrogen bromide, hydrogen bromide+chlorine, hydrogen iodide, etc., are employed. During dry etching, the resist structure may greatly change due to ion bombardment or heat, which affects the separation property.

### —Resist Layer Removing Step—

The resist layer removing step is a step of removing the resist layer used for pattern transfer onto the base substrate after the etching step.

The resist layer removing step can employ several methods for resist removal, including wet removal by use of liquid, dry removal/ashing where the resist layer is oxidized and gasified by plasma discharge of oxygen gas under reduced pressure, and dry remova/UV ashing where the resist layer is oxidized and gasified by exposure to ozone and UV light. As removal solutions, aqueous solutions such as sodium hydroxide aqueous solution, potassium hydroxide aqueous solution and ozone dissolved water, and organic solvent solutions such as mixtures of amines, dimethylsulfoxide and N-methylpyrrolidone are generally known. As an example of the organic solvent solutions, a 7:3 mixture (mass basis) of monoethanolamine and dimethylsulfoxide is known well.

Regarding removal treatment after magnetic layer patterning, it is preferable to employ a dry removal method for the purpose of removing both of the residual resist after patterning and interface binder that provides increased adhesion between the resist layer and substrate, as well as decreasing damages to the processed magnetic layer. It is also preferable to use oxygen ashing and UV ashing in combination.

### —Non-Magnetic Layer Embedding Step—

As shown in FIG. 1E, the non-magnetic layer embedding step is a step of embedding non-magnetic material 70 into concave portions of the convexo-concave pattern formed in the magnetic layer 12, so that the surface of the magnetic layer 12 is flattened.

### (Magnetic Recording Medium)

The magnetic recording medium of the present invention is manufactured by the manufacturing method of magnetic recording medium of the present invention.

The magnetic recording medium of the present invention includes at least the substrate 11 and magnetic layer 12 and, where necessary, includes additional member(s) or layer(s) appropriately selected.

### —Additional Member (Layer)—

The additional layer is not specifically limited and can be appropriately selected according to the intended purpose; for example, a non-magnetic material layer 70 and the like can be exemplified.

As shown in FIG. 1E, the non-magnetic material layer 70 is embedded into concave portions of the convexo-concave pattern formed in the magnetic layer 12 so that the surface of the magnetic layer 12 is flattened. Where necessary, a protective film is provided on the surface of the magnetic layer 12.

Examples of the non-magnetic materials include, for example, SiO₂, carbon, alumina, polymers such as methyl polymethacrylate (PMMA) and polystyrene (PS), and smoothing oils.

As the protective film, it is preferable to employ, for example, diamond-like carbon (DLC) or sputter carbon. Furthermore, a lubricant layer may be provided on the protective film.

### EXAMPLES

The prevent invention will be detailed below with reference to Examples which, however, shall not be construed as limiting the scope of the present invention.

### Example 1

As shown in FIG. 1A, a 20 nm-thick magnetic layer 12 made of Fe alloy was formed on a glass substrate 11 that is 2.5 inch in diameter, and a 2 nm-thick surface layer 13 made of carbon was formed on the magnetic layer 12 to prepare a laminate 10 for forming magnetic recording medium.

### <Activation Step and Surface Treatment Step>

A surface of the laminate 10 was subjected to oxygen plasma treatment so as to clean and activate a surface of the surface layer 13. Thereafter, surface treatment solution 1 (interface binder) described below was applied over the surface of the surface layer 13 by spin coating, and the surface was washed with propyleneglycol monoethyl ether acetate (PGMEA) solution, a commercially available organic solvent, followed by baking at 120° C. for 20 minutes. In this way the surface-treated laminate 10 was fabricated.

### —Surface Treatment Solution 1—

(1) 3-Acryloyloxypropyltrimethoxysilane (KBM-5103, Shin Etsu Chemical Co., Ltd.) . . . 1 g
(2) Propylene glycolo monoethyl ether acetate (PGMEA, commercially available organic solvent) . . . 99 g

### <Resist Layer Forming Step>

Resist solution 1 described below was prepared and applied over the surface-treated laminate 10 by spin coating to form a film with a thickness of 80 nm, and baking was carried out at 100° C. for 10 minutes to fabricate the laminate 10 on which a resist layer 14 is formed.

### <Resist Solution 1>

(1) Monofunctional monomer (VISCOAT #160, OSAKA ORGANIC CHEMICAL INDUSTRY LTD.) . . . 16 g
(2) UV curable polyfunctional monomer (ARONIX M220, Toagosei Co., Ltd.) . . . 2 g
(3) UV curable polyfunctional monomer (ARONIX M310, Toagosei Co., Ltd.) . . . 2 g
(4) Photopolymerization initiator (ethyl-2,4,6-triethylbenzoylphenylphosphinate) (TPO-L, BASF Corporation) . . . 0.4 g
(5) Surfactant (MEGAFAC) (TF-1396, Dainippon Ink and Chemicals, Inc.) . . . 0.02 g
(6) Commercially available organic solvent (PGMEA) . . . 80 g

A disc-shaped quarts mold structure 100 that is 2.5 inch in diameter and that has a convexo-concave pattern consisting of concentric radial stripes provided at 160 nm pitch (convex portion=80 nm in width and 80 nm in depth) on its surface was pressed against the laminate 10 provided with the resist layer 14, and pressure was applied uniformly over the entire surface of the resist layer 14 by means of the mold structure 100 as shown in FIG. 1B. In this way the convexo-concave pattern formed on the mold structure 100 was transferred to the resist layer 14, and the patterned resist layer 14 was set by irradiation with UV light at a dose of 200 mj/cm² from the mold structure 100 side, with the mold structure 100 being pressed against the resist layer 14. Thereafter, the mold structure 100 was separated, thereby preparing the laminate 10 on which the resist layer 14 having the transferred convexo-concave pattern is provided, as shown in FIG. 1C.

Note that the surface of the mold structure 100 used had been subjected to releasing treatment by use of OPTOOL DSX (Daikin Industries, Ltd.) prior to imprinting.

### <Etching Step>

As shown in FIG. 1D, dry etching by means of argon ion milling (ICP etching device NE-550, ULVAC Corporation) was carried out to the laminate 10 on which the resist layer 14 having the transferred convexo-concave pattern is provided, while using as a mask the cooled resist layer 14 having the transferred convexo-concave pattern. In this way, a convexo-concave pattern corresponding to the convexo-concave pattern formed in the resist layer 14 was formed in the magnetic layer 12.

### <Resist Layer Removing Step>

Subsequently, the surface of the magnetic layer 12 in which the convexo-concave pattern is formed was subjected to oxygen ashing treatment and subsequently to UV treatment, thereby removing residual pieces of the resist layer remained after magnetic layer patterning.

### <Non-Magnetic Layer Embedding Step>

As shown in FIG. 1E, non-magnetic material 70 was then embedded into concave portions of the magnetic layer 12 so as to flatten the surface thereof. In this way a magnetic recording medium 100 of Example 1 was prepared.

### Examples 2 to 9, Comparative Examples 1 to 5

Magnetic recording media of Examples 2 to 9 and Comparative Examples 1 to 5 were prepared by performing the same resist layer forming step, pattern forming step, etching step, resist layer removing step and non-magnetic layer embedding step as those in Example 1 except that the activation step and surface treatment step were respectively changed to those listed in Table 1.

It should be noted that although baking was carried out twice in Examples 1 to 8 (in the surface treatment step and resist layer forming step each), no surface treatment step was carried out and thus baking was carried out one time in the resist layer forming step in Comparative Examples 2, 3 and 5 and in Example 9 using resist solution No. 5 containing an interface binder therein.

In Table 1, “4-META” denotes 4-methacryloxyethyltrimellitic acid anhydride; “KR-55” denotes PRENACT, a titanate coupling agent (Ajinomoto Co., Inc.); “PAK-01” denotes a NIL photocurable resin (Toagosei Co., Ltd.); “KBM-9007” denotes γ-isocyanatepropyltriethoxysilane (Shin Etsu Chemical Co., Ltd.); “KBM-5103” denotes 3-acryloyloxypropyltrimethoxysilane (Shin Etsu Chemical Co., Ltd.); and “HMDS” denotes hexamethyldisilazane.

Resist solutions used for preparation of the magnetic recording media were those shown in Table 2.

In Table 2, “VISCOAT #160” denotes a monofunctional monomer (OSAKA ORGANIC CHEMICAL INDUSTRY LTD.); “VISCOAT #360” denotes a polyfunctional monomer (OSAKA ORGANIC CHEMICAL INDUSTRY LTD.); “ARONIX M5700” denotes a UV curable monofunctional monomer (Toagosei Co., Ltd.); “ARONIX M220” denotes a UV curable polyfunctional monomer (Toagosei Co., Ltd.); “ARONIX M310” denotes a UV curable polyfunctional monomer (Toagosei Co., Ltd.); “ARONIX M305” denotes a UV curable polyfunctional monomer (Toagosei Co., Ltd.); “KBM-9007” denotes γ-isocyanatepropyltriethoxysilane (Shin Etsu Chemical Co., Ltd.); “TF-1396” denotes a foam stabilizer (MEGAFAC, Dainippon Ink and Chemicals, Inc.); “TPO-L” denotes a photopolymerization initiator (ethyl-2,4,6-triethylbenzoylphenylphosphinate, BASF Corporation); and “PGMEA” demotes propylene glycol monoethyl ether acetate, a commercially available organic solvent.

<Evaluation of Laminate for Forming Magnetic Recording Medium to be Provided with Resist Layer>

Samples and intermediate samples in the course of manufacture prepared as follows were evaluated. Evaluation results are shown in Table 1.

### <Surface OH Group Ratio>

Using AXIS-ULTRA (X-ray photoelectron spectrometer, manufactured by Kratos Analytical Ltd.) the laminates after the first stage of the surface treatment step were measured for their ratio of the amount of OH group-attached carbon atoms to the total amount of carbon atoms. As an X-ray source, a monochromatic Kα X-ray of aluminum was employed.

### <Coatability>

The coating surfaces after spin coating in the resist layer forming step were evaluated based on the criteria shown below. It should be noted that “cissing” means formation of areas on the substrate that are not coated with the resist solution, and that “striation” means a surface defect visually recognized as stripes of interference colors that occur due to thickness variations in the radial direction.

A Cissing: NO Striation: NO

B Cissing: NO Striation: YES

C Cissing: YES Striation: YES

### <Adhesion>

Adhesion was evaluated in accordance with the method described in JIS K5600-5-6.

A No stripping

B 50 or more grids out of 100 grids remained without being stripped

C 50 or more grids out of 100 grids were stripped

Furthermore, the patterned resist layer 14 after imprinting was evaluated.

<Pattern Evaluation after Imprinting>

Using an optical microscope (MM-400, manufactured by Nikon Corporation) and a scanning electron microscope (SEM) (S-4800, manufactured by HITACHI Ltd.), the resist layer 14 after imprinting was observed and evaluated for the large area transfer property and presence of defects caused by displacement, on the basis of the occurrence of pattern stripping and the consistency of the pattern shape with that of the mold. Note that scanning electroscope microscopy was carried out at intermediate positions between the center and periphery of the sample, which are spaced at right angles to one another with respect to the center.

<Large Area Transfer Property as Evaluated using an Optical Microscope>

A No stripping observed over the entire surface

B Stripping observed partially or over the entire surface

### <Defects Caused by Displacement as Evaluated by SEM>

A The consistency of pattern height and pattern width with those of the mold were 80% or greater

B The consistency of pattern height and pattern width with those of the mold was less than 80% partially or over the entire surface, or pattern crumbling occurred.

### <Post-Process Dry Etching Property>

Using an atomic force microscope (AFF) (SPA-4000, manufactured by Seiko Instruments Inc.), the magnetic layer 12 that has a convexo-concave pattern formed by etching in accordance with the convexo-concave pattern formed in the resist layer 14 was observed at intermediate positions between the center and periphery of the sample, which are spaced at right angles to one another with respect to the center, thereby determining the formation of convexo-concave patterns. Note, however, that no evaluations were performed on the samples of Comparative Examples 2 to 5 because imprinting failed.

A The consistency of the height of patterned magnetic layer and pattern width with those of the mold was 80% or greater.

B The consistency of the height of patterned magnetic layer and pattern width with those of the mold was less than 80%.

### <Resist Removal Property>

The patterned surface of the magnetic layer after oxygen ashing treatment and UV treatment was evaluated for the presence of residual pieces of resist layer and interface binder on TOF-SIM (TOF-SIMS V, manufactured by ION-TOF) using a Bi⁺ primary ion gun.

A Residual: No

B Residual: YES

TABLE 1

| | | Laminate for forming | | | | | Activation and surface | | |
|---|---|---|---|---|---|---|---|---|---|
| | | magnetic recording media | | | | | treatment | | |
| | | | Magnetic layer | | Protective layer | | 1st stage | 2nd stage | Resist |
| No. | | Substrate | Material | Thickness | Material | Thickness | Dry | Wet | solution |
| 1 | Ex. 1 | 2.5-inch glass | Fe alloy | 20 nm | Carbon | 1.5 nm | O₂ plasma | KBM-5103 | No. 1 |
| 2 | EX. 2 | 3.5-inch glass | Fe alloy | 20 nm | Carbon | 1.5 nm | O₂ plasma | KBM-5103 | No. 1 |
| 3 | Ex. 3 | 2.5-inch glass | Fe alloy | 20 nm | Carbon | 1.5 nm | O₂ plasma | KBM-9007 | No. 2 |
| 4 | Ex. 4 | 3.5-inch glass | Fe alloy | 20 nm | Carbon | 1.5 nm | O₂ plasma | KBM-9007 | No. 2 |
| 5 | Ex. 5 | 2.5-inch glass | Fe alloy | 20 nm | Carbon | 1.5 nm | O₂ plasma | KBM-5103 | PAK-01 |
| 6 | Ex. 6 | 2.5-inch glass | Fe alloy | 20 nm | Carbon | 1.5 nm | UV (5 min) | KBM-5103 | No. 3 |
| 7 | Ex. 7 | 2.5-inch glass | Fe alloy | 20 nm | Carbon | 1.5 nm | UV (5 min) | KBM-5103 | No. 4 |
| 8 | Comp. | 2.5-inch glass | Fe alloy | 20 nm | Carbon | 1.5 nm | O₂ plasma | KR-55 | No. 4 |
| | Ex. 1 | | | | | | | | |
| 9 | Ex. 8 | 2.5-inch glass | Fe alloy | 20 nm | Carbon | 1.5 nm | O₂ plasma | 4-META | No. 4 |
| 10 | Comp. | 2.5-inch glass | Fe alloy | 20 nm | Carbon | 1.5 nm | O₂ plasma | — | PAK-01 |
| | Ex. 2 | | | | | | | | |
| 11 | Comp. | 2.5-inch glass | Fe alloy | 20 nm | Carbon | 1.5 nm | UV (5 min) | — | PAK-01 |
| | Ex. 3 | | | | | | | | |
| 12 | Comp. | 2.5-inch glass | Fe alloy | 20 nm | Carbon | 1.5 nm | O₂ plasma | HMDS | No. 4 |
| | Ex. 4 | | | | | | | | |
| 13 | Ex. 9 | 2.5-inch glass | Fe alloy | 20 nm | Carbon | 1.5 nm | O₂ plasma | — | No. 5 |
| 14 | Comp. | 2.5-inch glass | Fe alloy | 20 nm | Carbon | 1.5 nm | — | — | PAK-01 |
| | Ex. 5 | | | | | | | | |

| | | Evaluation of laminate on which | | | Pattern evaluation | | | Resist |
|---|---|---|---|---|---|---|---|---|
| | | resist | | | after imprinting | | | removal |
| | | layer is to be formed | | | Large area | Defects due | Post process | property |
| | | OH group | | | transfer | to pattern | dry etching | O2 ashing + |
| No. | | ratio (%) | Coatability | Adhesion | property | displacement | property | UV |
| 1 | Ex. 1 | 42 | A | A | A | A | A | A |
| 2 | EX. 2 | 42 | A | A | A | A | A | A |
| 3 | Ex. 3 | 42 | A | A | A | A | A | A |
| 4 | Ex. 4 | 42 | A | A | A | A | A | A |
| 5 | Ex. 5 | 42 | A | A | A | A | A | A |
| 6 | Ex. 6 | 42 | A | A | A | A | A | A |
| 7 | Ex. 7 | 42 | A | A | A | A | A | A |
| 8 | Comp. | 42 | A | A | A | A | A | B |
| | Ex. 1 | | | | | | | |
| 9 | Ex. 8 | 42 | A | A | A | A | A | A |
| 10 | Comp. | 42 | A | B | B | B | — | A |
| | Ex. 2 | | | | | | | |
| 11 | Comp. | 42 | A | B | B | B | — | A |
| | Ex. 3 | | | | | | | |
| 12 | Comp. | 42 | A | B | B | B | — | A |
| | Ex. 4 | | | | | | | |
| 13 | Ex. 9 | 42 | A | A | A | A | A | A |
| 14 | Comp. | 13 | A | B | B | B | — | A |
| | Ex. 5 | | | | | | | |

TABLE 2

| | VISCOAT | ARONIX | ARONIX | ARONIX | ARONIX | VISCOAT | KBM- | TF- | | |
|---|---|---|---|---|---|---|---|---|---|---|
| No | #160 | M5700 | M220 | M310 | M305 | #360 | 9007 | 1396 | TPO-L | PGMEA |
| 1 | 16 g | | 2 g | 2 g | | | | 0.02 g | 0.4 g | 80 g |
| 2 | | 16 g | 2 g | 2 g | | | | 0.02 g | 0.4 g | 80 g |
| 3 | 8 g | | 6 g | 3 g | 3 g | | | 0.02 g | 0.4 g | 80 g |
| 4 | 8 g | | 6 g | | 3 g | 3 g | | 0.02 g | 0.4 g | 80 g |
| 5 | 8 g | | 6 g | | 3 g | 3 g | 1 g | 0.02 g | 0.4 g | 80 g |

The above results demonstrate that the use of the interface binder of the present invention imparts coatability to the resist composition (resist layer 14) as well as adhesion between the resist layer 14 and the laminate 10 (surface layer 13), whereby disc-shaped large area patterning was enabled without abnormalities such as defects due to pattern displacement while removing the processed resist layer 14. Thus, it succeeded in manufacturing a laminate 10 for forming magnetic recording medium, which has a pattern substantially identical to the convexo-concave pattern on the mold structure. On the other hand, when compounds different from the interface binder of the present invention were used as in Comparative Examples 1 and 4, it resulted in poor adhesion or poor resist layer 14 removal after patterning of the magnetic layer 12. For this reason, such compounds are problematic when patterning the magnetic layer 12. Moreover, when no interface binders were used as in Comparative Examples 2, 3 and 5, it resulted in poor adhesion, leading to poor imprinting property. Hexamethyldisilazne (HMDS) was crosslinked with the surface layer 13, but failed to be crosslinked with the resist layer 14.

What is claimed is:

1. An interface binder for binding a resist layer and a laminate for forming magnetic recording medium having a substrate and a magnetic layer, the interface binder comprising:
a first functional group crosslinkable with a surface of the laminate; and
a second functional group crosslinkable with the resist layer.

2. The interface binder according to claim 1, wherein the laminate includes a hydroxyl group on the surface thereof, the first functional group is crosslinkable with the hydroxyl group, the resist layer contains a crosslinkable monomer, and the second functional group is crosslinkable with the crosslinkable monomer.

3. The interface binder according to claim 1, wherein the interface binder is decomposable by any of oxygen plasma treatment, oxygen ashing treatment and UV ozone treatment.

4. The interface binder according to claim 1, wherein the interface binder is composed of at least one of a silane coupling agent and a carboxylic anhydride.

5. A nanoimprint resist composition, comprising:
an interface binder for binding a resist layer and a laminate for forming magnetic recording medium having a substrate and a magnetic layer, wherein the interface binder comprises a first functional group crosslinkable with a surface of the laminate, and a second functional group crosslinkable with the resist layer.

6. A laminate for forming magnetic recording medium, comprising:
a substrate;
a magnetic layer; and
a layer on a surface of the laminate,
wherein the layer on the surface of the laminate is composed of an interface binder for binding a resist layer and the laminate, wherein the interface binder comprises a first functional group crosslinkable with the surface of the laminate, and a second functional group crosslinkable with the resist layer.

7. A method of manufacturing a magnetic recording medium having a laminate for forming magnetic recording medium having a substrate and a magnetic layer, the method comprising:
treating a surface of the laminate with an interface binder for binding a resist layer and the laminate, wherein the interface binder comprises a first functional group crosslinkable with the surface of the laminate, and a second functional group crosslinkable with the resist layer.

8. The method according to claim 7, further comprising forming a resist layer on the laminate whose surface has been treated in the surface treatment.

9. The method according to claim 7, further comprising activating the surface of the laminate by any of UV irradiation, oxygen plasma treatment, oxygen ashing treatment, alkali treatment and acid treatment, so that the mole ratio of OH group-containing elements becomes 20% or more over the surface of the laminate.

10. The method according to claim 7, further comprising ablating, by any of oxygen plasma treatment, oxygen ashing treatment and UV ozone treatment, a single or multiple layers that contain at least the interface binder and that are formed in the surface treatment step at a position closer to the laminate surface than is the magnetic layer.

11. A magnetic recording medium, comprising:
a laminate for forming magnetic recording medium, the laminate having a substrate and a magnetic layer,
wherein the magnetic recording medium is produced by a method of manufacturing a magnetic recording medium which comprises:
treating a surface of the laminate with an interface binder for binding a resist layer and the laminate, wherein the interface binder comprises a first functional group crosslinkable with the surface of the laminate, and a second functional group crosslinkable with the resist layer.
